(19) United States
(12) Patent Application Publication
(10) Pub. No.: US 2025/0310450 A1
(43) Pub. Date: Oct. 2, 2025

(54) STORAGE MEDIUM STORING CONTROL PROGRAM FOR INFORMATION PROCESSING APPARATUS, CONTROL METHOD FOR INFORMATION PROCESSING APPARATUS, AND INFORMATION PROCESSING APPARATUS

(71) Applicant: CANON KABUSHIKI KAISHA, Tokyo (JP)

(72) Inventor: RYO DEGAWA, Ibaraki (JP)

(21) Appl. No.: 19/079,706

(22) Filed: Mar. 14, 2025

(30) Foreign Application Priority Data
Mar. 26, 2024 (JP) 2024-049485

(51) Int. Cl. H04N 1/00

(52) U.S. Cl. CPC H04N 1/00427; H04N 1/00421; H04N 2201/0094

(57) ABSTRACT

A mechanism that can set a file format of image data obtained by reading a document with an image processing apparatus when a user uses, with an information processing apparatus, software that can be used in common for image processing apparatuses of a plurality of manufacturers. A non-transitory computer-readable storage medium storing a program that supports software capable of commonly being used in image processing apparatuses of a plurality of manufactures and causes a computer of an information processing apparatus to execute a method including displaying a screen through which a user operation to set a file format of image data that is obtained by reading a document by an image processing apparatus is received, and setting the file format of the image data in accordance with the user operation accepted through the screen.

### BACKGROUND OF THE INVENTION

### Field of the Invention

The present invention relates to a storage medium storing a control program for an information processing apparatus, a control method for the information processing apparatus, and the information processing apparatus.

### Description of the Related Art

There is a known configuration in which an instruction to read a document is issued to an image processing apparatus (including a scanning apparatus) connected to an information processing apparatus while using a scan driver installed in the information processing apparatus as control software for the image processing apparatus. An OS (Operating System), which is basic software, is installed in the information processing apparatus, and the scan driver is configured in accordance with specifications defined by the OS and is called from the OS to operate. On the other hand, a manufacturer of an image processing apparatus can provide a means for instructing an image processing apparatus to read a document by using the OS by providing a scan driver conforming to the specification of the OS. In this specification, a manufacturer includes a vendor of an image processing apparatus.

In recent years, a standard class driver (hereinafter, also referred to as a “standard driver”) that can be used in common among image processing apparatuses manufactured by a plurality of manufacturers is provided in Windows (registered trademark). The standard driver is included in an OS package and can be used easily by connecting an arbitrary image processing apparatus to an information processing apparatus. Therefore, the standard driver is highly convenient because it is not necessary to separately install a model-specific scan driver suitable for an image processing apparatus. The standard driver is assumed to enable a scan function in accordance with scan function information generated based on information obtained from the connected image processing apparatus. Thus, a user using the standard driver can set a scan function corresponding to capability of a connected image processing apparatus even though the user uses one standard driver.

However, a scan function that can be set by the user is limited to a function that can be achieved only by the standard driver, and thus a function unique to a manufacturer cannot be set. As a technique related to this point, Japanese Patent Laid-Open Publication No. 2021-033526 discloses a program to support a printing function of general-purpose software, although it is a technique for a printing function different from a scanning function.

One of functions of a scan driver unique to a manufacture is a file format setting function. The file format setting function is a function capable of setting a file format of image data obtained by the image processing apparatus reading a document. Therefore, when a scan driver unique to the manufacturer is used in the information processing apparatus, the user using the scan driver can set the file format of the image data obtained by the image processing apparatus reading the document by the file format setting function. Note that file formats that can be set by the file format setting function include, for example, JPEG, TIFF, PDF, XPS, and OOXML. However, when the standard driver is used in the information processing apparatus, the user using the standard driver cannot use the file format setting function, and thus cannot set the file format of the image data obtained by the image processing apparatus reading the document.

### SUMMARY OF THE INVENTION

The present invention provides a mechanism that can set a file format of image data obtained by reading a document with an image processing apparatus when a user uses, with an information processing apparatus, software that can be used in common for image processing apparatuses of a plurality of manufacturers.

Accordingly, an aspect of the present invention provides A non-transitory computer-readable storage medium storing a program that supports software capable of commonly being used in image processing apparatuses of a plurality of manufactures and causes a computer of an information processing apparatus to execute a method including displaying a screen through which a user operation to set a file format of image data that is obtained by reading a document by an image processing apparatus is received, and setting the file format of the image data in accordance with the user operation accepted through the screen.

According to the present invention, when a user uses, with the information processing apparatus, the software that can be used in common for image processing apparatuses of a plurality of manufacturers, the user can set the file format of image data obtained by reading a document with the image processing apparatus.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of a scanning system.

FIGS. 2A and 2B are block diagrams illustrating software configurations of the scanning system.

FIGS. 3A to 3C are views illustrating examples of a print setting screen and advanced setting screens.

FIG. 4 is a flowchart illustrating an editing process for scan function information performed by a scan function expansion unit of an expansion application in a first embodiment.

FIGS. 5A to 5C are tables illustrating examples of respective lists of capability information obtained from a scanning apparatus, scan functions supported by the expansion application, and scan functions supported by general-purpose scan software.

FIG. 6 is a sequence chart illustrating procedures of a scan application, the general-purpose scan software, the expansion application, and the scanning apparatus in the first embodiment.

FIG. 7 is a flowchart illustrating the process of the expansion application in the sequence chart in FIG. 6.

FIG. 8 is a flowchart illustrating the process of the scanning apparatus in the sequence chart in FIG. 6.

FIG. 9 is a flowchart illustrating an editing process for the scan function information performed by the scan function expansion unit of the expansion application in a second embodiment.

FIG. 10 is a sequence chart illustrating procedures of the scan application, the general-purpose scan software, the expansion application, and the scanning apparatus in the second embodiment.

FIG. 11 is a flowchart illustrating the process of the expansion application in the sequence chart in FIG. 10.

FIG. 12 is a sequence chart illustrating procedures of the scan application, the general-purpose scan software, the expansion application, and the scanning apparatus in a third embodiment.

FIG. 13 is a sequence chart illustrating procedures of the scan application, the general-purpose scan software, the expansion application, and the scanning apparatus in the third embodiment.

FIG. 14 is a sequence chart illustrating procedures of the scan application, the general-purpose scan software, the expansion application, and the scanning apparatus in a fourth embodiment.

FIG. 15 is a flowchart illustrating the process of the expansion application in the sequence chart in FIG. 14.

FIG. 16 is a sequence chart illustrating procedures of the scan application, the general-purpose scan software, the expansion application, and the scanning apparatus in a fifth embodiment.

FIG. 17 is a flowchart illustrating the process of the expansion application until the advanced setting screen is displayed in the sequence chart in FIG. 16.

### DESCRIPTION OF THE EMBODIMENTS

Hereafter, embodiments according to the present invention will be described in detail by referring to the drawings. However, configurations described in the following embodiments are merely examples, and the scope of the present invention is not limited by the configurations described in the embodiments. For example, not all combinations of features described in the embodiments are necessarily essential to the solving means of the present invention. For example, each unit constituting the present invention can be replaced with any configuration capable of exhibiting the same function. In addition, an arbitrary constituent may be added. Any two or more configurations (features) of the embodiments can be combined.

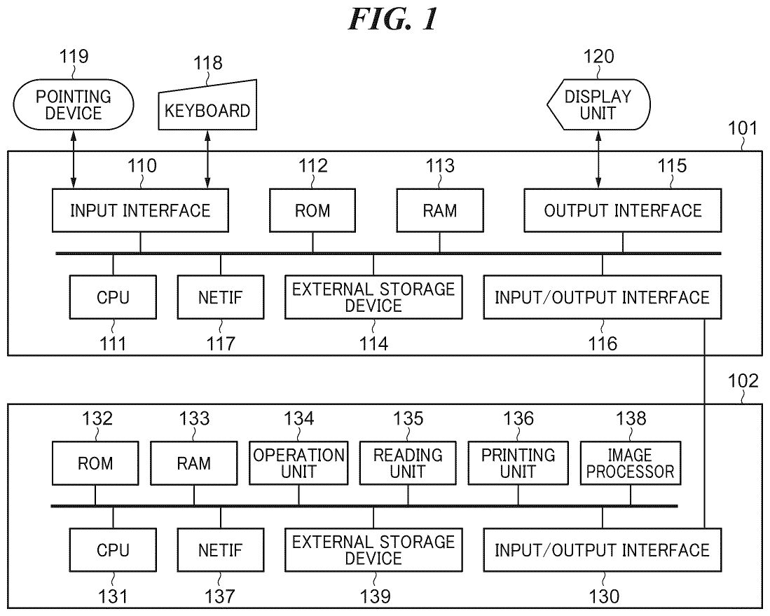

The first embodiment will now be described with reference to FIGS. 1 to 8.

FIG. 1 is a block diagram illustrating a hardware configuration of a scanning system. As shown in FIG. 1, the scanning system includes a host computer 101 and a scanning apparatus 102. The host computer 101 (an information processing apparatus) may be a desktop personal computer, a smartphone, a notebook personal computer, or a tablet terminal. In FIG. 1, the host computer 101 includes an input interface 110, a CPU 111 (computer), a ROM 112, a RAM 113, an external storage device 114, an output interface 115, an input/output interface 116, and a NETIF 117. Further, the input interface 110 is connected to input devices, such as a keyboard 118 and a pointing device 119, and the output interface 115 is connected to a display device such as a display unit 120.

For example, a scan setting screen, an advanced setting screen, and the like, which will be described later, are displayed on the display unit 120. The NETIF 117 is a network interface and controls data transfer with an external apparatus via a network. The ROM 112 stores an initialization program. The external storage device 114 is, for example, an HDD (Hard Disk Drive) or an SSD (Solid State Drive). The external storage device 114 stores an application program group, an operating system (OS), and other various data. The RAM 113 is used as a work memory when various programs stored in the external storage device 114 are executed. This enables various programs to operate in the host computer 101. In the first embodiment, the CPU 111 performs a process in accordance with a code of a program stored in the ROM 112 or the external storage device 114. Thus, functions (mentioned later) of the host computer 101 and processes shown in flowcharts and sequence charts (mentioned later) are executed.

The scanning apparatus 102 is connected to the host computer 101 via the input/output interface 116. The scanning apparatus 102 includes an input/output interface 130, a CPU 131, a ROM 132, a RAM 133, an operation unit 134, a reading unit 135, a printing unit 136, a NETIF 137, an image processor 138, and an external storage device 139. The input/output interface 116 of the host computer 101 is connected to the input/output interface 130. The input/output interface 130 of the scanning apparatus 102 and the input/output interface 116 of the host computer 101 may be connected via a wired network or a wireless network.

The CPU 131 totally controls of the scanning apparatus 102. The ROM 132 is a memory storing programs etc. The RAM 133 is a memory temporarily storing a program and image data when the CPU 131 executes the program. The reading unit 135 is a scanner and reads an image of a document to generate image data. The printing unit 136 prints an image on a sheet based on the image data. The printing unit 136 is not essential. The NETIF 137 is a network interface and controls data transfer with an external apparatus via a network. The image processor 138 performs various image editing processes on the input image data.

The external storage device 139 is, for example, an HDD or an SSD. The external storage device 139 stores programs, image data, etc. In the first embodiment, the scanning apparatus 102 will be described as an example of an image processing apparatus. The scanning apparatus 102 is an electrophotographic digital multifunction peripheral having a plurality of functions, such as copy, print, and FAX, in addition to a document reading function. The image processing apparatus is not limited to this, and may be, for example, a multifunction peripheral using another process such as an inkjet method, or a scanner having only a document reading function. In the first embodiment, the host computer 101 and the scanning apparatus 102 are separately configured, but they may be configured as one apparatus.

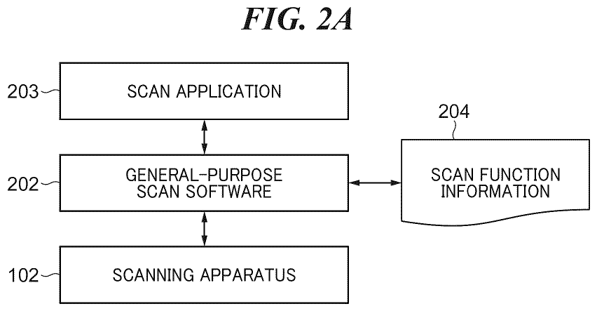

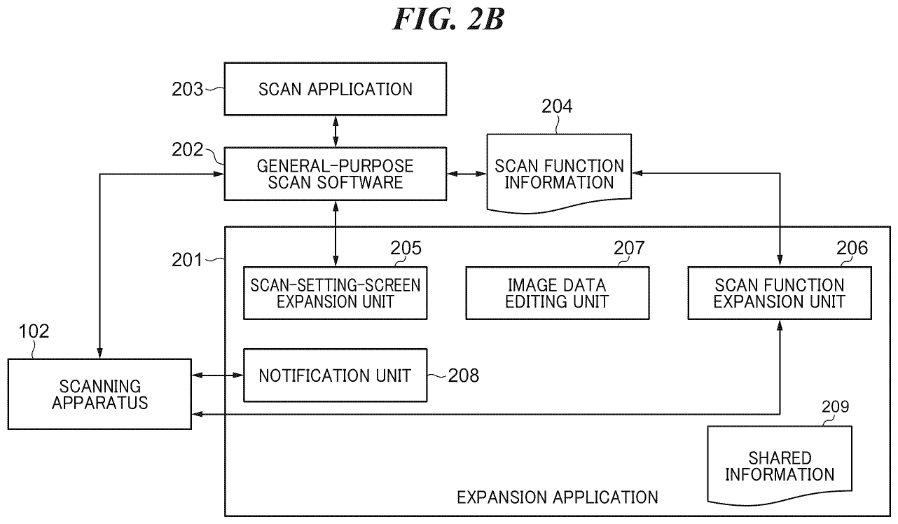

FIGS. 2A and 2B are block diagrams illustrating software configurations of the scanning system. The following description is based on the scanning system in which the host computer 101 is equipped with Windows 11 (registered trademark) of Microsoft (registered trademark) as the OS. FIG. 2A is the block diagram illustrating a general configuration in a case where an expansion application 201 (a program) is not associated with a general-purpose scan software 202 (software) and the scanning apparatus 102. FIG. 2B is a block diagram illustrating a configuration in which the expansion application 201 is associated with the general-purpose scan software 202 and the scanning apparatus 102. The software configurations illustrated in FIGS. 2A and 2B are stored in the external storage device 114 of the host computer 101.

First, the configuration of the scanning system in which the expansion application 201 is not associated with the general-purpose scan software 202 and the scanning apparatus 102 will be described with reference to FIG. 2A. In FIG. 2A, a scan application 203, the general-purpose scan software 202, and scan function information 204 are shown as a general configuration of the software configuration of the scanning system. The scan application 203 is software that captures a content (image data) obtained by the scanning apparatus 102. The scan application 203 corresponds to, for example, a document creation application or an image editing application. Upon receiving a scan request from the user, the scan application 203 issues a scan instruction to the OS. The scan instruction includes scan setting information to instruct operations of the general-purpose scan software 202 and the scanning apparatus 102.

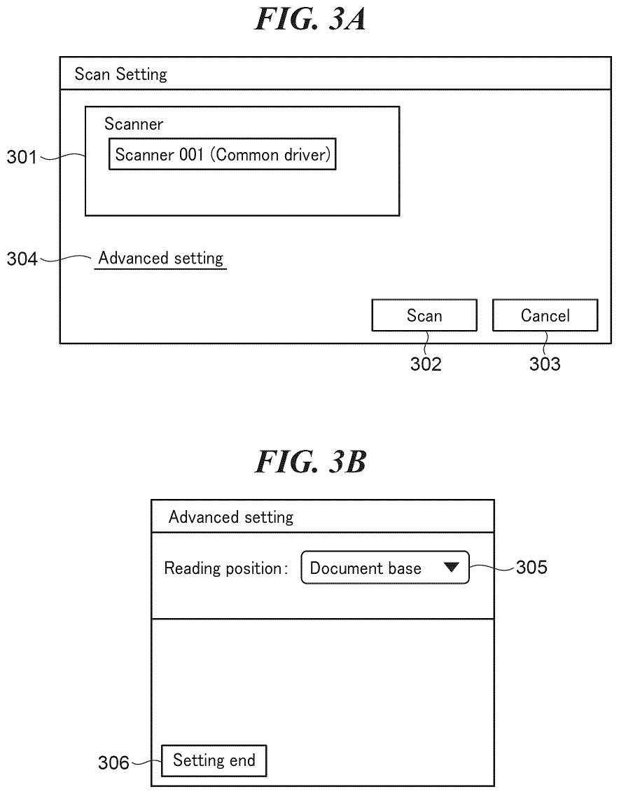

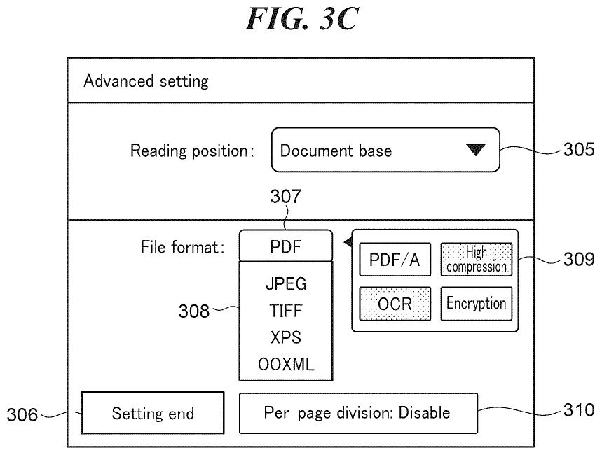

The scan application 203 can display a scan setting screen provided by any of the general-purpose scan software 202, the OS, and the scan application 203 in order to execute the scan instruction. When an advanced setting button in the scan setting screen is selected, the general-purpose scan software 202 additionally displays an advanced setting screen. The scan setting screen and the advanced setting screen will be described in detail with reference to FIGS. 3A to 3C described below. The advanced setting screen includes a setting item (hereinafter, referred to as a “control”) that enables the user to set a scan function in accordance with the capability information (settable information) of the general-purpose scan software 202, and a control indicating a set value.

The general-purpose scan software 202 determines a scan capability based on the scan function information 204. The scan function information 204 is data indicating all scan functions that can be set by the user, set values thereof, and scan functions in which exclusive relationships between set values are described. The scan function information 204 is included in a configuration file of the general-purpose scan software 202 and is stored in the external storage device 114 as an unchangeable file. The scan function information 204 can also be dynamically generated by the general-purpose scan software 202 or the OS. Specifically, the general-purpose scan software 202 or the OS may obtain attribute data of the scanning apparatus 102 from the scanning apparatus 102 and generate the scan function information 204 in accordance with attribute information in the obtained attribute data. When the scan function information 204 is dynamically generated, the generated scan function information 204 can be edited.

The attribute data of the scanning apparatus 102 includes attribute information indicating functions that can be set by the user in the scanning apparatus 102 (the capability of the scanning apparatus 102) and set values related to the attribute information. This information is stored in the RAM 113. With this configuration, the general-purpose scan software 202 allows the user to set a scan function usable in each scanning apparatus in accordance with a scanning apparatus connected to the host computer 101. That is, even when a scanning apparatus having a different function or a scanning apparatus developed by a different manufacturer is connected, the general-purpose scan software 202 allows the user to set a scan function usable in accordance with a connected scanning apparatus. Note that the manufacturer may be a vendor of scanning apparatus as described above.

In the first embodiment, the general-purpose scan software 202 is a standard class driver that controls execution of a scanning process on the basis of a standard scan protocol called Mopria. The general-purpose scan software 202 obtains the capability information of the connected scanning apparatus 102 and generates the scan function information 204 based on the capability information so that the user can set the scan function supported by the connected scanning apparatus 102. However, the general-purpose scan software 202 does not support a file format setting function. This is because the file format setting function is a manufacturer's unique function.

The file format setting function is a function that can set a file format of image data obtained by the scanning apparatus 102 reading a document. File formats that can be set by the file format setting function include JPEG, TIFF, PDF, XPS, and OOXML, for example. In the first embodiment, the user can set the file format when the image data obtained by the scanning apparatus 102 reading the document is transmitted from the scanning apparatus 102 to the host computer 101 by using the file format setting function. In the following description, a file format of image data when the image data is transmitted from the scanning apparatus 102 to the host computer 101 is referred to as a “transmission format”.

Next, a configuration of the scanning system in which the expansion application 201 is associated with the general-purpose scan software 202 and the scanning apparatus 102 will be described with reference to FIG. 2B. In FIG. 2B, the expansion application 201 is shown in addition to the general configuration of the software configuration of the scanning system shown in FIG. 2A. Note that the configuration and process not particularly mentioned below are the same as those in FIG. 2A. The expansion application 201 is software to support the function of the general-purpose scan software 202 and is not included in the OS in advance (is not packaged together).

Therefore, the user needs to operate the host computer 101 and download the expansion application 201 from a server to the host computer 101 via the Internet and install it. Alternatively, the expansion application 201 may be automatically installed in response to the connection of the scanning apparatus 102 to the host computer 101. Specifically, when the scanning apparatus 102 is connected to the host computer 101, the OS of the host computer 101 obtains device identification information from the scanning apparatus 102. Further, the OS downloads the expansion application 201 corresponding to the obtained device identification information from the server to the host computer 101 via the Internet and installs the expansion application 201. That is, the general-purpose scan software 202 and the expansion application 201 are stored in the host computer 101 as different files. The expansion application 201 may be installed in the host computer 101 when the CPU 111 of the host computer 101 reads the expansion application 201 stored in the storage medium.

Note that the general-purpose scan software 202 and the expansion application 201 may be updated and upgraded, but the update processes are also performed at different timings. That is, the timing at which the host computer 101 obtains the general-purpose scan software 202 is different from the timing at which the host computer 101 obtains the expansion application 201. Further, a trigger for the host computer 101 to obtain the general-purpose scan software 202 is also different from a trigger for the host computer 101 to obtain the expansion application 201. When the expansion application 201 is installed, the OS associates the expansion application 201 with the general-purpose scan software 202 and the scanning apparatus 102.

As shown in FIG. 2B, the expansion application 201 has a scan-setting-screen expansion unit 205, a scan function expansion unit 206, an image data editing unit 207, and a notification unit 208. The expansion application 201 has shared information 209 that can be accessed in common by the units. An actual state of the shared information 209 is a file stored in the external storage device 114 or information stored in the RAM 113 in the host computer 101. The expansion application 201 writes and reads information to and from the shared information 209 by using an API (Application Program Interface) provided by the OS. The expansion application 201 may end the operation every time the process of each unit is finished. In this case, the OS activates the expansion application 201 every time a request to use each unit is received. Further, the expansion application 201 may cancel the process in the process of each unit. When the expansion application 201 cancels the process, the job being processed is deleted by the OS.

Upon receiving a scan request from the user, the scan application 203 issues a scan instruction to the OS. In the configuration in FIG. 2B, the scan application 203 can display the scan setting screen as with the configuration in FIG. 2A. Further, in the configuration of FIG. 2B, when the advanced setting button on the scan setting screen is selected, an advanced setting screen provided by the expansion application 201 is additionally displayed. Specifically, the advanced setting screen provided by the scan-setting-screen expansion unit 205 of the expansion application 201 is displayed. The advanced setting screen provided by the expansion application 201 includes a setting item (hereinafter, referred to as a “control”) that allows the user to set a scan function and a control indicating its set value. The scan-setting-screen expansion unit 205 can store the information about the advanced setting set by the user in the shared information 209 as the scan setting information.

The image data editing unit 207 obtains image data from the scanning apparatus 102 and edits the obtained image data. The image data editing unit 207 obtains the scan setting information from the shared information 209 and edits the image data in accordance with the advanced setting. The expansion application 201 may obtain image data via the general-purpose scan software 202 and edit the obtained image data in accordance with the advanced setting. In the configuration in FIG. 2B, the user sometimes does not set the file format. In this case, the general-purpose scan software 202 may issue the scan instruction to the scanning apparatus 102 without passing through the expansion application 201 as in the configuration in FIG. 2A.

The scan function expansion unit 206 can edit the scan function information 204 generated by the general-purpose scan software 202 or the OS. Thus, the scan function expansion unit 206 can add a function provided by the expansion application 201. The scan function expansion unit 206 can add a function (for example, a file format setting function) that is supported by the scanning apparatus 102 but is not supported by the general-purpose scan software 202, and an exclusive relationship between set values of scan functions. The OS activates the scan function expansion unit 206 when the expansion application 201 is first associated with the scanning apparatus 102 and the general-purpose scan software 202. Further, the OS may activate the scan function expansion unit 206 at another timing (for example, an activation timing of the OS).

The notification unit 208 can display a notification to the user in response to an error occurring in the scanning apparatus 102. For example, when a reading jam error occurs in the scanning apparatus 102, the general-purpose scan software 202 detects the error, and the OS causes the display unit 120 to display a message using a notification function called a toast notification, which is a function of the OS. When the user selects the toast notification with the pointing device 119, the notification unit 208 is called by the OS, and a UI (user interface) screen of the notification unit 208 is displayed. The notification unit 208 can display, for example, a detailed message of the scan jam error and a jam handling method on the UI screen.

The configuration of the expansion application 201 is not limited to the configuration including all of the above-described functions (units), and may include a part of the functions or may include other functions. The expansion application 201 may also be simply referred to as scan software. As described above, the expansion application 201 has at least one of the following four functions. The first is a function of displaying a setting screen (the scan-setting-screen expansion unit 205). The second is a function of editing the image data according to the advanced setting (the image data editing unit 207). The third is a function of supporting the function of the general-purpose scan software (the scan function expansion unit 206). The fourth is a function of displaying a screen in response to occurrence of an error in the scanning apparatus 102 (the notification unit 208). The expansion application 201, the general-purpose scan software 202, and the scan application 203 are activated by the CPU 111 being read from the external storage device 114, developed to the RAM 113, and executed.

Next, examples of the scan setting screen and the advanced setting screen will be described with reference to FIGS. 3A to 3C. FIG. 3A is a view illustrating the scan setting screen displayed by the scan application 203. FIG. 3B is a view illustrating the advanced setting screen displayed when the expansion application 201 is not included as shown in FIG. 2A. FIG. 3C is a view illustrating the advanced setting screen displayed when the expansion application 201 is included as shown in FIG. 2B. A unit or a module for displaying the scan setting screen is not limited to the above units. For example, the scan-setting-screen expansion unit 205 may be configured to only generate a display screen. In this case, the scan-setting-screen expansion unit 205 transmits the generated display screen to the scan application 203 via the general-purpose scan software 202. The scan application 203 displays the display screen obtained in this way.

First, the scan setting screen shown in FIG. 3A will be described. The scan setting screen in FIG. 3A is a UI screen including controls 301 to 304. The control 301 includes one or more setting items to urge the user to select a scanner (i.e., a scanning apparatus) used for reading a document. The control 302 is a button to start scanning. The control 303 is a button to cancel scanning. The control 304 is an advanced setting button. When the control 304 is selected with the pointing device 119, an additional advanced setting screen is displayed by the general-purpose scan software 202 or the scan-setting-screen expansion unit 205.

Next, the advanced setting screen shown in FIG. 3B will be described. The advanced setting screen in FIG. 3B is an additional advanced setting screen displayed by the general-purpose scan software 202 when the expansion application 201 is not included. Further, the advanced setting screen in FIG. 3B is a UI screen including controls 305 and 306. The control 305 allows the user to set the reading position, and FIG. 3B shows a state where an “document base” is set. The control 306 is a button to end the setting. When the control 306 is selected with the pointing device 119, the advanced setting screen in FIG. 3B is closed.

Next, the advanced setting screen shown in FIG. 3C will be described. FIG. 3C is an additional advanced setting screen displayed by the scan-setting-screen expansion unit 205 when the expansion application 201 is included. The advanced setting screen in FIG. 3C is a UI screen in which a control 307, a list 308, an option setting 309, and a per-page division 310 are added to the advanced setting screen in FIG. 3B. The list 308, the option setting 309, and the per-page division 310 are also controls. The control 307 allows the user to set a file format (a transmission format in the first embodiment). FIG. 3C show a state where “PDF” is set.

When the control 307 is selected with the pointing device 119, the list 308 dynamically expands the setting items of the file format. The list 308 includes “JPEG”, “TIFF”, “XPS”, and “OOXML” as the setting items of the file format in addition to “PDF” that is currently set. The user can switch the file format to be set by selecting a desired file format from the list 308 with the pointing device 119. The file formats displayed in the list 308 are examples. In addition, the list 308 may display file formats such as “PNG” for recording image data, “DOC” for recording document data, and “PPT” for recording a presentation document. Further, the list 308 may display various file formats such as “XLS” for recording a spreadsheet document, and “TXT” and “CSV” for recording a text file.

The option setting 309 allows the user to set an additional option related to each file format. FIG. 3C shows a state where the additional options of “high compression” and “OCR” are set. In the option setting 309, detailed settings are possible for each file format. Since the setting in the option setting 309 is a well-known general setting, a detailed description thereof is omitted. The additional option “PDF/A” is a setting item indicating that the format conversion is performed not to the file format of the normal PDF but to the file format compliant with PDF/A.

The additional option of “high compression” is a setting item indicating that image data is efficiently compressed so that data size becomes smaller than the normal document data by synthesizing objects while optimizing settings, such as resolution and color setting, for each object. The additional option of “OCR” is a setting item indicating that text data extracted by performing an OCR process on the image read by the scanning apparatus 102 is superimposed on the image as invisible text data so that a character portion in the image can be searched. The additional option of “encryption” is a setting item indicating that the image data obtained by the scanning apparatus 102 is encrypted using a password.

In the option setting 309, in addition to the setting items of the four additional options displayed in FIG. 3C, for example, a setting item related to another file format such as an additional option of “electronic signature addition” can be set in the same manner. In the option setting 309, display or non-display of a setting item is switched for each set file format. For example, the additional option of “OCR” is displayed in the option setting 309 when “PDF” is set as the file format, but is not displayed in the option setting 309 when “JPEG” is set as the file format. Alternatively, all options may be displayed for any file formats in the option setting 309 and an error notification may be performed when an option unsupported by the selected file format is selected with the pointing device 119. Specifically, for example, when “OCR” displayed in the option setting 309 is selected with the pointing device 119 in a case where “JPEG” is set as the file format, an error notification is performed.

The per-page division 310 is a control to allow the user to set an additional option of dividing the image data obtained by the scanning apparatus 102 that includes a plurality of pages into files to be output for respective pages. FIG. 3C shows a state where the per-page division is disable. Note that when a file format such as JPEG that does not support the per-page division is set, the per-page division 310 may be hidden or grayed out, or an error notification may be issued when the per-page division 310 is enabled. In all the embodiments described in this specification, the functions related to the setting of the option setting 309 and the setting of the per-page division 310 shall be included in the functions related to the setting of the file format.

Hereinafter, a reason why the controls are different between the advanced setting screens in FIGS. 3B and 3C will be described. The advanced setting screen is generated by referring to the scan capability determined on the basis of the scan function information 204. However, since the general-purpose scan software 202 does not support the file format setting function, the file format setting function cannot be added to the scan function information 204. Even if the scan function information 204 originally includes the file format setting function, the general-purpose scan software 202 cannot interpret the file format setting function included in the scan function information 204.

Thus, the general-purpose scan software 202 cannot display the control 307 to set the file format on the advanced setting screen. On the other hand, if the expansion application 201 is included, the scan function expansion unit 206 adds the file format setting function to the scan function information 204, and the scan-setting-screen expansion unit 205 displays the advanced setting screen generated by referring to the scan capability. Thus, the expansion application 201 can display the control 307 to set the file format on the advanced setting screen. Note that the advanced setting screen in FIG. 3C may additionally include a control for an expanded function other than the file format setting function.

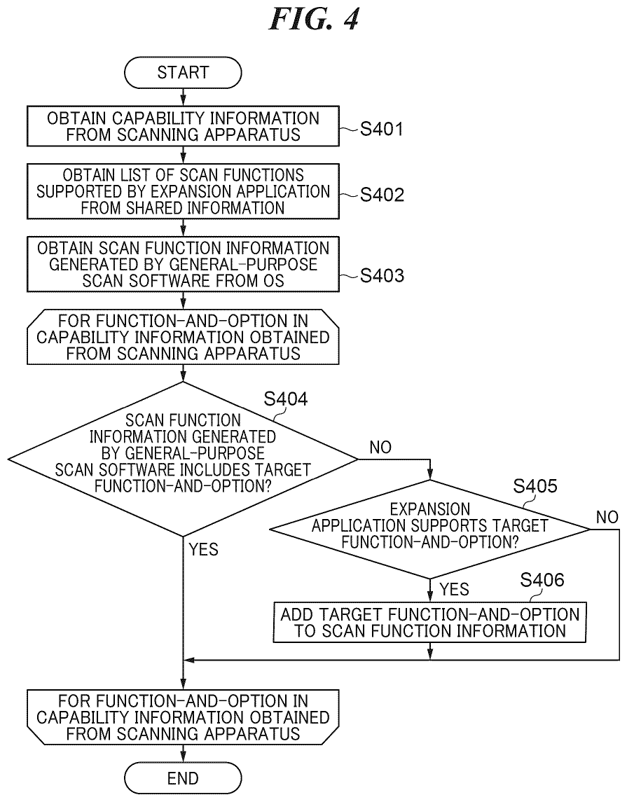

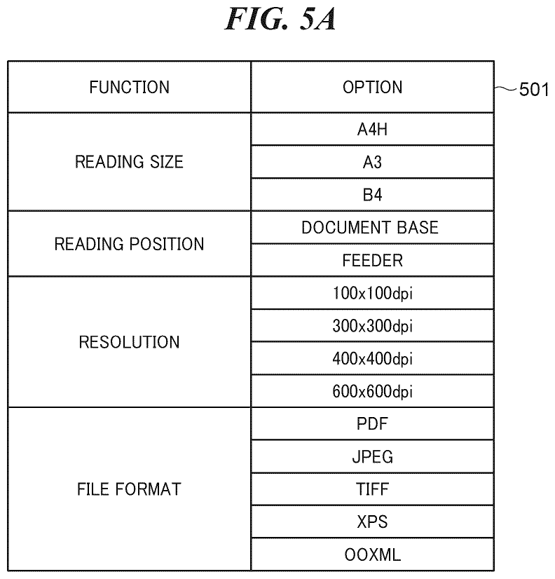

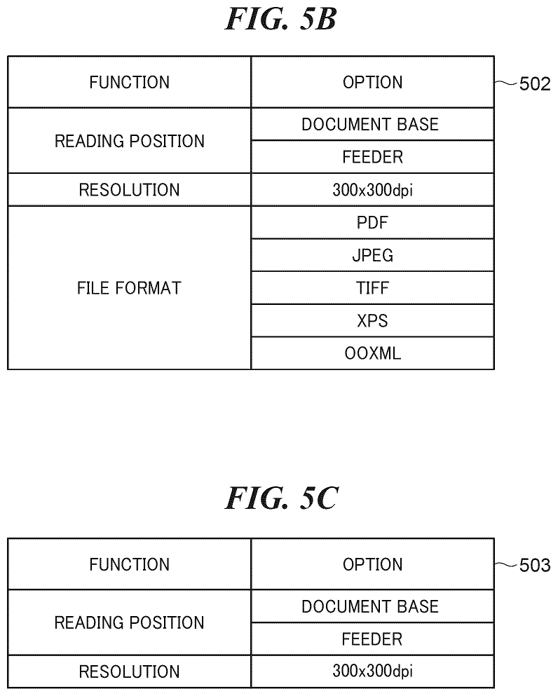

Here, a flow of an editing process to edit the scan function information 204 performed by the scan function expansion unit 206 of the expansion application 201 will be described using a flowchart shown in FIG. 4. Each step of the flowchart shown in FIG. 4 is achieved by the CPU 111 in the host computer 101 executing the expansion application 201 that is read from the external storage device 114 and developed onto the RAM 113. When the editing process of the flowchart in FIG. 4 is started, the CPU 111 obtains capability information from the scanning apparatus 102 with the scan function expansion unit 206 in a step S401. The capability information includes attribute information indicating functions that can be set in the scanning apparatus 102 and set values associated with the attribute information. A table 501 in FIG. 5A shows an example of a list of pieces of capability information obtained from the scanning apparatus 102. As shown in the table 501, the information about functions such as a reading size and a file format, and information about options that are set values settable for the respective functions can be obtained as the capability information from the scanning apparatus 102.

Referring back to the description of FIG. 4. Next, the CPU 111 obtains a list of scan functions supported by the expansion application 201 from the shared information 209 with the scan function expansion unit 206 in a step S402. The list of the scan functions supported by the expansion application 201 includes all functions that can be processed by the expansion application 201 and their set values, and is stored in the shared information 209. A table 502 in FIG. 5B shows an example of a list of scan functions supported by the expansion application 201. The list of the scan functions supported by the expansion application 201 may be updated when updating the expansion application 201.

Referring back to the description of FIG. 4. Subsequently, the CPU 111 obtains the scan function information 204 generated by the general-purpose scan software 202 from the OS with the scan function expansion unit 206 in a step S403. A table 503 in FIG. 5C shows an example of a list of scan functions supported by the general-purpose scan software 202. The general-purpose scan software 202 generates the scan function information 204 based on the table 501 that is the list of the pieces of capability information obtained by the general-purpose scan software 202 from the scanning apparatus 102. In addition, the scan function information 204 generated by the general-purpose scan software 202 includes only the functions supported by the general-purpose scan software 202 and their set values among the pieces of capability information obtained from the scanning apparatus 102.

Accordingly, the functions included in the scan function information 204 generated by the general-purpose scan software 202 are limited. For example, the table 501, which is the list of the pieces of capability information obtained from the scanning apparatus 102, includes the function of the file format (hereinafter, also referred to as the “file format setting function”). However, since the general-purpose scan software 202 does not support the file format setting function, the scan function information 204 generated by the general-purpose scan software 202 does not include the file format setting function. Therefore, the scan function expansion unit 206 adds a function or an option to the scan function information 204, and thus the expansion application 201 can compensate for a lack of function of the general-purpose scan software 202. The scan function expansion unit 206 can also delete unnecessary functions and options from the scan function information 204 generated by the general-purpose scan software 202.

Referring back to the description of FIG. 4. The following process in steps S404, S405, and S406 is repeatedly performed for the functions and options of the capability information obtained from the scanning apparatus 102 in the step S401. That is, the process in the steps S404, S405, and S406 is repeatedly performed for fourteen items from “reading size: A4H” to “file format: OOXML” included in the table 501. First, the CPU 111 determines with the scan function expansion unit 206 whether the scan function information 204 generated by the general-purpose scan software 202 includes a target function-and-option (a combination of a function and an option, for example, “reading size: A4H”) under processing in the step S404.

When the CPU 111 determines, with the scan function expansion unit 206, that the scan function information 204 generated by the general-purpose scan software 202 includes the function-and-option under processing, the process returns to the step S404. At this time, the CPU 111 selects the next item from the functions and options of the capability information obtained from the scanning apparatus 102 with the scan function expansion unit 206, and performs the process in the step S404 again. However, if the CPU 111 has performed the last item of the functions and options of the capability information obtained from the scanning apparatus 102 with the scan function expansion unit 206, the process of the flowchart in FIG. 4 ends. On the other hand, if the CPU 111 determines with the scan function expansion unit 206, that the scan function information 204 generated by the general-purpose scan software 202 does not include the function-and-option under processing, the process proceeds to the step S405.

Specifically, for example, the “reading position: document base” shown in the table 501 that is the list of the pieces of capability information of the scanning apparatus 102 is also included in the table 503 that is the list of the pieces of capability information of the general-purpose scan software 202. Therefore, in this case, the CPU 111 determines with the scan function expansion unit 206 that the scan function information 204 generated by the general-purpose scan software 202 includes the function-and-option under processing. On the other hand, the “reading size: A4H” shown in the table 501 is not included in the table 503. Therefore, in this case, the CPU 111 determines with the scan function expansion unit 206 that the scan function information 204 generated by the general-purpose scan software 202 does not include the function-and-option under processing. As a result, the process proceeds to the step S405.

Next, the CPU 111 determines with the scan function expansion unit 206 whether the expansion application 201 supports the target function-and-option under processing in the step S405. When the CPU 111 determines with the scan function expansion unit 206 that the expansion application 201 supports the target function-and-option under processing, the process proceeds to the step S406. Specifically, for example, the function-and-option of “file format: PDF” under processing is also included in the table 502 that is the list of the pieces of capability information of the expansion application 201. Therefore, in this case, the CPU 111 determines with the scan function expansion unit 206 that the expansion application 201 supports the target function-and-option under processing. As a result, the process proceeds to the step S406.

In contrast, when the CPU 111 determines with the scan function expansion unit 206 that the expansion application 201 does not support the target function-and-option under processing, the process returns to the step S404. At this time, the CPU 111 selects the next item from the functions and options of the capability information obtained from the scanning apparatus 102 with the scan function expansion unit 206, and performs the process in the step S404 again. However, if the CPU 111 has performed the last item of the functions and options of the capability information obtained from the scanning apparatus 102 with the scan function expansion unit 206, the process of the flowchart in FIG. 4 ends.

In a next step S406, the CPU 111 adds, with the scan function expansion unit 206, the target function-and-option under processing to the scan function information 204. Thereafter, the process returns to the step S404. At this time, the CPU 111 selects the next item from the functions and options of the capability information obtained from the scanning apparatus 102 with the scan function expansion unit 206, and performs the process in the step S404 again. However, if the CPU 111 has performed the last item of the functions and options of the capability information obtained from the scanning apparatus 102 with the scan function expansion unit 206, the process of the flowchart in FIG. 4 ends.

As described above, the CPU 111 adds, with the scan function expansion unit 206, the functions and options, which are not supported by the general-purpose scan software 202 but are supported by the scanning apparatus 102 and the expansion application 201, to the scan function information 204. The scan capability is determined on the basis of the scan function information 204 edited by the editing process described above. Further, the scan-setting-screen expansion unit 205 generates a display screen based on the determined scan capability. This enables to display the advanced setting screen in FIG. 3C by adding the function unsupported by the general-purpose scan software 202 and selecting options to be displayed.

In other words, the CPU 111 of the host computer 101 changes the controls included in the advanced setting screen in FIG. 3C with the expansion application 201 in accordance with the capability information of the general-purpose scan software 202. In addition, the CPU 111 of the host computer 101 changes the controls included in the advanced setting screen in FIG. 3C with the expansion application 201 in accordance with the capability information of the scanning apparatus 102.

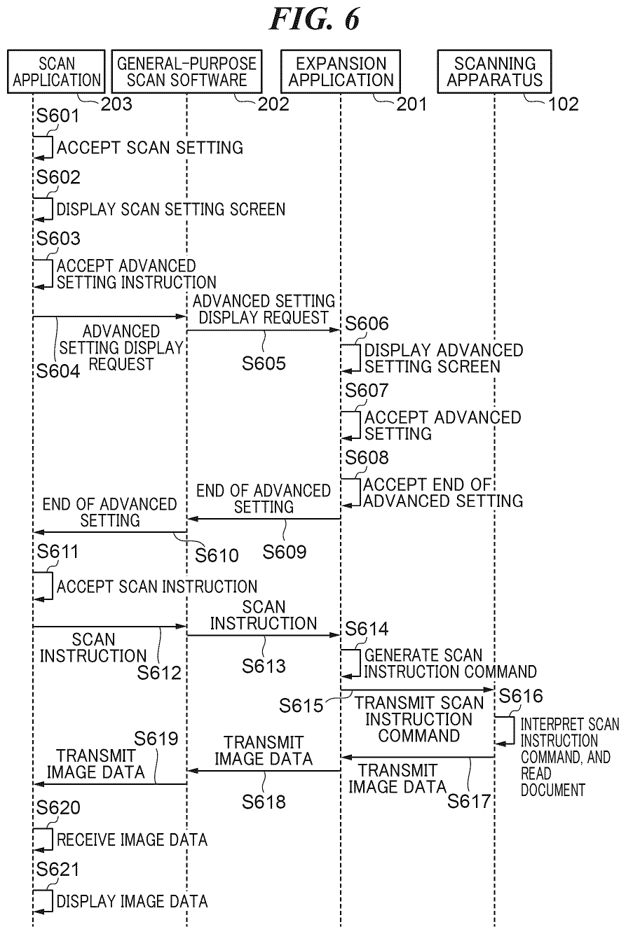

Next, a sequence (method) of the scanning process executed by the scan application 203, the general-purpose scan software 202, the expansion application 201, and the scanning apparatus 102 after the scan application 203 accepts the scan setting will be described with reference to FIG. 6. Steps other than steps of the scanning apparatus 102 in FIG. 6 are implemented by the CPU 111 activating the scan application 203, general-purpose scan software 202, and expansion application 201 in the host computer 101. On the other hand, the steps of the scanning apparatus 102 in FIG. 6 are achieved by the CPU 131 developing a program read from the ROM 132 or the external storage device 139 onto the RAM 133 and executing the program in the scanning apparatus 102. The sequence in FIG. 6 is based on an assumption that the scanning system has the software configuration in FIG. 2B.

First, the CPU 111 of the host computer 101 accepts a scan setting instruction by the user with the scan application 203 in a step S601. The user can issue the scan setting instruction to the scan application 203 by operating the keyboard 118 or the pointing device 119. Next, the CPU 111 displays the scan setting screen in FIG. 3A on the display unit 120 with the scan application 203 in a step S602. Subsequently, the CPU 111 accepts an advanced setting instruction with the scan application 203 in a step S603. The user can issue the advanced setting instruction by selecting the control 304 by operating the pointing device 119.

Next, the CPU 111 issues an advanced setting display request to the general-purpose scan software 202 with the scan application 203 in a step S604. Subsequently, the CPU 111 issues the advanced setting display request to the expansion application 201 with the general-purpose scan software 202 in a step S605. If the scanning system has the software configuration in FIG. 2A unlike the assumption, the advanced setting screen in FIG. 3B is displayed on the display unit 120 with the general-purpose scan software 202 as described above.

Next, the CPU 111 (a display control unit) displays the advanced setting screen in FIG. 3C on the display unit 120 with the scan-setting-screen expansion unit 205 of the expansion application 201 in a step S606 (a display step). As described above, the scan function expansion unit 206 adds the file format setting function to the scan function information 204. Therefore, the scan-setting-screen expansion unit 205 generates the advanced setting screen in FIG. 3C by referring to the scanning capability determined based on the scan function information 204 after the addition, and displays the advanced setting screen on the display unit 120. In the first embodiment, since the resolution supported by the expansion application 201 is only one type of “300×300 dpi”, it is unnecessary to cause the user to select the resolution, and this setting item is not displayed on the advanced setting screen in FIG. 3C. However, even if the resolutions cannot be selected, the resolutions may be displayed on the advanced setting screen in FIG. 3C and may be clearly indicated to the user.

Subsequently, the CPU 111 accepts the advanced setting with the scan-setting-screen expansion unit 205 in a step S607. In the case of the advanced setting screen in FIG. 3C, the scan-setting-screen expansion unit 205 accepts the advanced setting to “reading position: document base”, “file format: PDF”, etc. by the user. Further, the CPU 111 stores the set states in the RAM 113. Next, the CPU 111 accepts the end of the advanced setting with the scan-setting-screen expansion unit 205 in a step S608. Further, the CPU 111 instructs the scan-setting-screen expansion unit 205 to write the accepted set states in the scan setting information. The user can instruct the end of the advanced setting by selecting the control 306 by operating the pointing device 119.

When the advanced setting is completed, the scan-setting-screen expansion unit 205 stores the scan setting information in the shared information 209. The scan-setting-screen expansion unit 205 closes the advanced setting screen in FIG. 3C on the display unit 120. In addition, when the accepted set states are written in the scan setting information, a set state of function-and-option that cannot be selected by the user, such as the resolution, may be written in the scan setting information.

Subsequently, the CPU 111 transmits the end of the advanced setting to the general-purpose scan software 202 with the expansion application 201 in a step S609. Next, the CPU 111 transmits the end of the advanced setting to the scan application 203 with the general-purpose scan software 202 in a step S610. Subsequently, the CPU 111 accepts a scan instruction with the scan application 203 in a step S611. The user can issue the scan instruction by selecting the control 302 by operating the pointing device 119. Next, the CPU 111 issues a scan instruction to the general-purpose scan software 202 with the scan application 203 in a step S612.

Subsequently, the CPU 111 issues the scan instruction to the expansion application 201 with the general-purpose scan software 202 in a step S613. In a next step S614, the CPU 111 generates, with the expansion application 201, a scan instruction command based on the scan setting information written in the step S608. If the set state of the function-and-option that cannot be selected by the user, such as the resolution, is not written in the scan setting information, the expansion application 201 may add the set state to the scan instruction command when the scan instruction command is generated in the step S614. Alternatively, the set state of the function-and-option that cannot be selected by the user, such as the resolution, may not be added to the scan instruction command, and the scanning apparatus 102 may be operated with a default value.

Next, the CPU 111 transmits the scan instruction command to the scanning apparatus 102 with the expansion application 201 in a step S615. As a result, the expansion application 201 issues the scan instruction to the scanning apparatus 102. Subsequently, the CPU 131 of the scanning apparatus 102 interprets the scan instruction command and reads the document in a step S616. Further, the CPU 131 performs a necessary image process according to the scan instruction on the image data obtained by reading the document. In the case of the advanced setting screen in FIG. 3C, the CPU 131 converts, for example, image data obtained by reading the document into the file format set in the control 307. As a result, the image data in the file format of PDF is generated. Subsequently, the CPU 131 transmits the generated image data to the expansion application 201 of the host computer 101 in a step S617.

Next, the CPU 111 of the host computer 101 transmits the image data to the general-purpose scan software 202 with the expansion application 201 in a step S618. Subsequently, the CPU 111 transmits the image data to the scan application 203 with the general-purpose scan software 202 in a step S619. Next, the CPU 111 causes the scan application 203 to receive image data in step S620. Subsequently, the CPU 111 displays the image data with the scan application 203 in a step S621. Thereafter, the sequence in FIG. 6 ends.

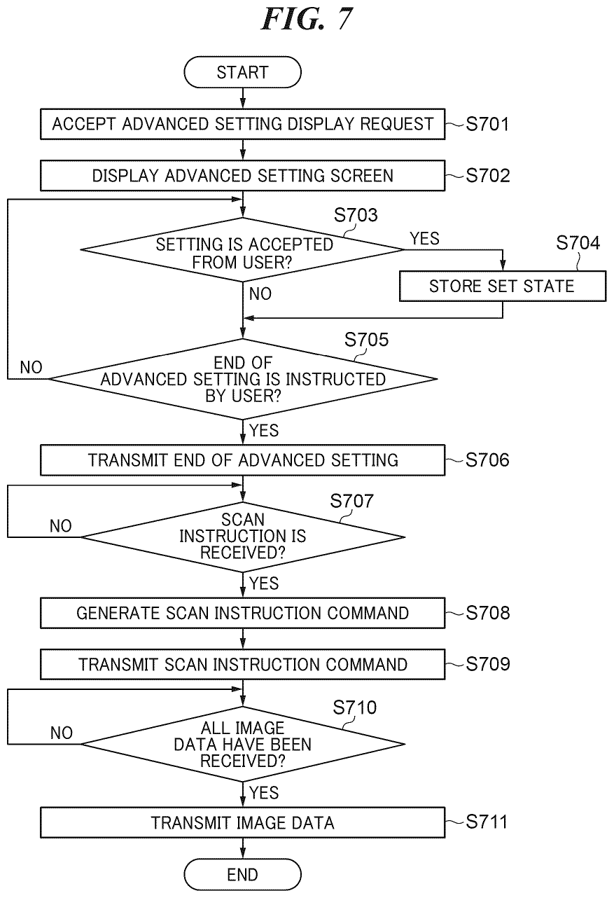

Next, the process flow of the expansion application 201 after the scan application 203 accepts the scan setting will be described with reference to FIG. 7. Each step shown in a flowchart in FIG. 7 is achieved by the CPU 111 of the host computer 101 developing the expansion application 201 read from the external storage device 114 onto the RAM 113 and executing the expansion application 201. When the process of the flowchart in FIG. 7 is started, the CPU 111 first accepts the advanced setting display request with the expansion application 201.

Next, the CPU 111 displays the advanced setting screen in FIG. 3C on the display unit 120 with the scan-setting-screen expansion unit 205 of the expansion application 201 in a step S702. This is because the scan function expansion unit 206 adds the file format setting function to the scan function information 204 as described above. That is, the scan-setting-screen expansion unit 205 displays the advanced setting screen in FIG. 3C, which is generated by referring to the scanning capability determined based on the scan function information 204 after the addition, on the display unit 120.

Subsequently, the CPU 111 determines with the scan-setting-screen expansion unit 205 whether a setting is accepted from the user in a step S703. When the CPU 111 determines with the scan-setting-screen expansion unit 205 that the setting is accepted from the user, the process proceeds to a step S704. On the other hand, when the CPU 111 determines with the scan-setting-screen expansion unit 205 that no setting is accepted from the user, the process proceeds to a step S705. The CPU 111 accepts the advanced setting with the scan-setting-screen expansion unit 205 in the step S704. Further, the CPU 111 stores the accepted set state in the RAM 111.

Subsequently, the CPU 111 determines whether the end of the advanced setting is instructed from the user with the scan-setting-screen expansion unit 205 in a step S705. The user can instruct the end of the advanced setting by selecting the control 306 by operating the pointing device 119. When the CPU 111 determines with the scan-setting-screen expansion unit 205 that the user instructs the end of the advanced setting, the process proceeds to a step S706. At this time, when accepting the instruction of the end of the advanced setting with the scan-setting-screen expansion unit 205, the CPU 111 writes the accepted set state in the scan setting information. On the other hand, when the CPU 111 determines with the scan-setting-screen expansion unit 205 that the instruction of the end of the advanced setting is not accepted from the user, the process returns to the step S703.

In a step S706, the CPU 111 transmits the end of the advanced setting to the general-purpose scan software 202 with the expansion application 201. Subsequently, the CPU 111 determines with the expansion application 201 whether the scan instruction is received from the general-purpose scan software 202 in a step S707. When the CPU 111 determines with the expansion application 201 that the scan instruction is received from the general-purpose scan software 202, the process proceeds to a step S708. On the other hand, when the CPU 111 determines with the expansion application 201 that no scan instruction is received from the general-purpose scan software 202, the process returns to the step S707. Then, the CPU 111 determines with the expansion application 201 whether the scan instruction is received from the general-purpose scan software 202 again.

In a step S708, the CPU 111 generates the scan instruction command based on the scan setting information written in the step S705 with the expansion application 201. The expansion application 201 generates the scan instruction command in the step S708 using a method of expanding a command of a standard protocol. This expansion method describes a dedicated command in an expansion area of the command of the standard protocol. Note that the scan instruction command may be generated by adding a command of a unique standard to the end of the command of the standard protocol or by the expansion application 201 overwriting the command of the standard protocol with a unique command system. When the expansion application 201 issues the instruction, the CPU 111 may instruct and communicate using a manufacture's original protocol regardless of the standard protocol. Next, the CPU 111 transmits the scan instruction command to the scanning apparatus 102 with the expansion application 201 in a step S709. As a result, the expansion application 201 issues the scan instruction to the scanning apparatus 102.

Subsequently, the CPU 111 determines with the expansion application 201 whether all image data have been received from the scanning apparatus 102 in a step S710. When the CPU 111 determines with the expansion application 201 that all the image data have been received from the scanning apparatus 102, the process proceeds to a step S711. On the other hand, when the CPU 111 determines with the expansion application 201 that not all the image data have been received from the scanning apparatus 102, the process returns to the step S710. Therefore, the expansion application 201 determines whether all the image data have been received from the scanning apparatus 102 again. The CPU 111 transmits all the image data obtained by receiving to the general-purpose scan software 202 with the expansion application 201 in the step S711. Thereafter, the process of the flowchart in FIG. 7 ends.

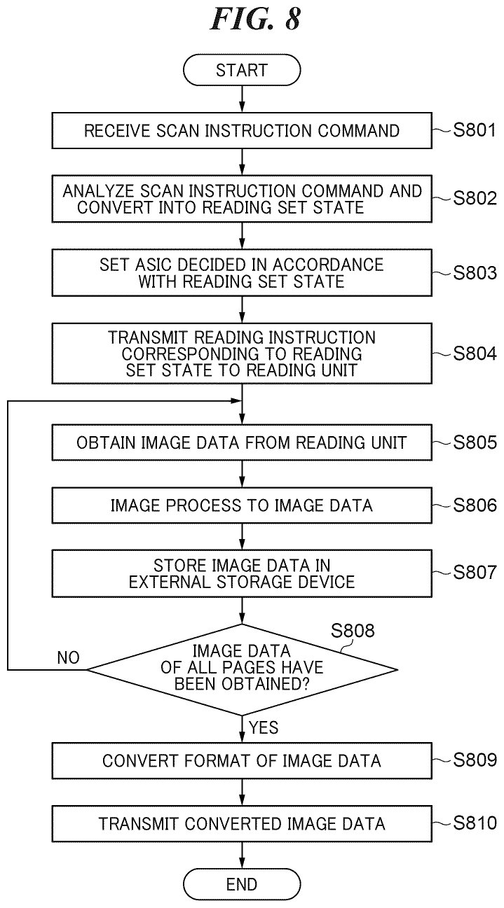

Next, a flow of a process of the scanning apparatus 102 after the scan application 203 accepts the scan setting will be described with reference to FIG. 8. Each step of the flowchart in FIG. 8 is achieved by the CPU 131 developing a program read from the ROM 132 or the external storage device 139 onto the RAM 133 and executing the program in the scanning apparatus 102. When the process of the flowchart in FIG. 8 is started, the CPU 131 receives the scan instruction command transmitted from the host computer 101. In the first embodiment, the CPU 131 receives the scan instruction command transmitted from the expansion application 201.

In a next step S802, the CPU 131 analyzes the scan instruction command received in the step S801 and converts the scan instruction command into a reading set state used when reading a document. The reading set state here includes “reading position: document base”, “resolution: 300×300 dpi”, and “file format: PDF”. In a next step S803, the CPU 131 decides an ASIC of the image processor 138 to be used when reading the document in accordance with the reading set state converted in the step S802 and set the decided ASIC. In a step S804, the CPU 131 transmits a reading instruction corresponding to the reading set state converted in the step S802 to the reading unit 135.

The CPU 131 obtains image data from the reading unit 135 in a step S805. In a step S806, the CPU 131 applies the image process to the image data obtained in the step S805 with the image processor 138. In this case, the image process to convert the resolution of the image data to “300×300 dpi” is performed. When the reading unit 135 can read at “resolution: 300×300 dpi”, the CPU 131 may obtain image data at “resolution: 300×300 dpi” with the reading unit 135 and may not execute the image process in the step S806. The CPU 131 stores the image data in the external storage device 139 in a step S807.

The CPU 131 determines whether the image data of all pages have been obtained in a step S808. When the CPU 131 determines that the image data of not all pages have been obtained, the process returns to the step S805. As a result, the CPU 131 obtains the image data of the next page from the reading unit 135. On the other hand, when the CPU 131 determines that the image data of all pages have been obtained, the process proceeds to a step S809.

In the step S809, the CPU 131 converts the format of the image data stored in the step S801 with the image processor 138 in accordance with the scan instruction command received in the step S807. In this case, since the “file format: PDF” is set, the image data is converted into the file format of PDF. When the file format of “JPEG”, “TIFF”, “XPS”, or “OOXML” is set, the image data is converted into the file format of JPEG, TIFF, XPS, or OOXML. The CPU 131 transmits the image data to the host computer 101 in a step S810. In the first embodiment, the CPU 131 transmits the image data of which the format is converted in the step S809 to the expansion application 201. Thereafter, the process of the flowchart in FIG. 8 ends.

As described above, the expansion application 201 edits the scan function information 204 based on the capability information obtained from the scanning apparatus 102, the scan function supported by the general-purpose scan software 202, and the scan function supported by the expansion application 201. Further, when accepting the advanced setting display request, the expansion application 201 generates and displays the advanced setting screen in FIG. 3C with reference to the scanning capability determined based on the scan function information 204. Thus, the expansion application 201 allows the user to set the file format in the control 307 on the advanced setting screen in FIG. 3C. On the other hand, when receiving the scan instruction command to which the file format set by the user is reflected, the scanning apparatus 102 converts the format of the image data obtained by reading the document into the file format set by the user and then transmits the image data to the host computer 101. In this way, the expansion application 201 can use the file format setting function when the user uses the general-purpose scan software 202, which can be used in common for image processing apparatuses of a plurality of manufacturers, in the host computer 101.

Although the advanced setting screen in FIG. 3C, which enables the setting of the reading position and the setting of the file format, is additionally displayed under the configuration in FIG. 2B without displaying the advanced setting screen in FIG. 3B in the first embodiment, the present invention is not limited thereto. For example, when the advanced setting display request is issued to the general-purpose scan software 202 in the step S604, the CPU 111 may additionally display the advanced setting screen in FIG. 3B first, which enables the setting of the reading position, with the general-purpose scan software 202. Further, after the advanced setting on the advanced setting screen in FIG. 3B is completed, the CPU 111 may issue the advanced setting display request to the expansion application 201 with the general-purpose scan software 202. Through such a process, the CPU 111 may additionally display the advanced setting screen in FIG. 3C in which the reading position is already set and the file format is not set with the expansion application 201. Alternatively, the CPU 111 may cause the expansion application 201 to additionally display the control 307, the list 308, the option setting 309, and the per-page division 310 on the advanced setting screen in FIG. 3B in which the reading position has been set.

Although the CPU 111 issues the scan instruction to the expansion application 201 with the general-purpose scan software 202 in the first embodiment, the present invention is not limited thereto. For example, the CPU 111 may issue a scan instruction to the expansion application 201 with the scan application 203. Further, the user may directly issue the scan instruction to the expansion application 201 by selecting a control for the scan instruction arranged on the advanced setting screen in FIG. 3C by operating the pointing device 119.

Although the CPU 111 transmits the image data from the expansion application 201 to the scan application 203 via the general-purpose scan software 202 under the configuration in FIG. 2B in the first embodiment, the present invention is not limited thereto. For example, the CPU 111 may directly transmit the image data from the expansion application 201 to the scan application 203 without passing through the general-purpose scan software 202. Further, the CPU 111 may directly transmit the image data from the scanning apparatus 102 to the scan application 203 without passing through the expansion application 201 and the general-purpose scan software 202. Further, the CPU 111 may store the image data received from the scanning apparatus 102 in the external storage device 114 and transmit only information about a file path of a storage destination to the expansion application 201, the general-purpose scan software 202, and the scan application 203. When there are a plurality of image data, the CPU 111 obtains all the image data and then transmits all the image data in the first embodiment, the present invention is not limited thereto. For example, the CPU 111 may transmit the obtained image data at any time.

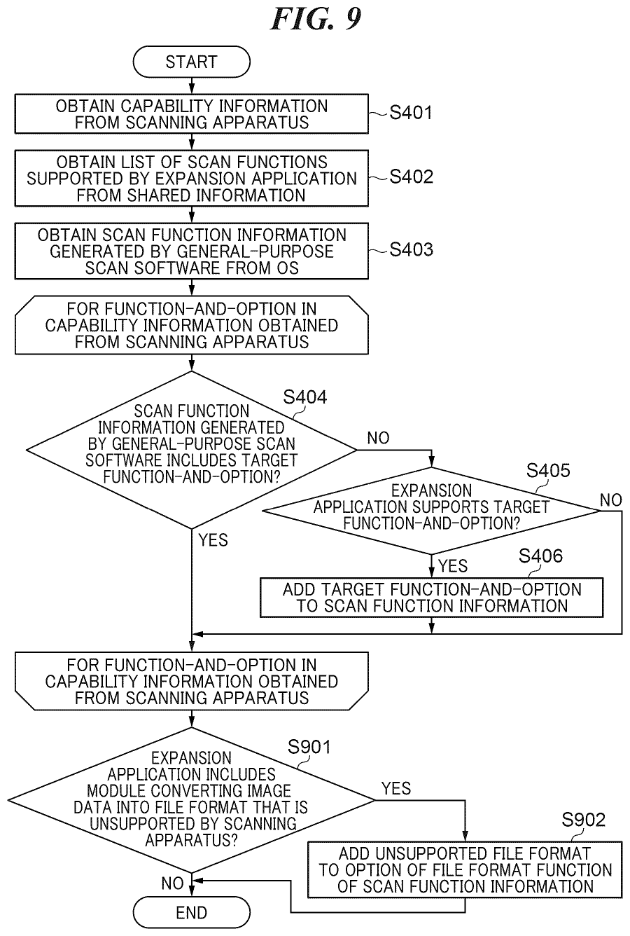

A second embodiment will now be described with reference to FIGS. 9 to 11. In the first embodiment, the scanning apparatus 102 interprets the scan instruction command generated based on the scan setting information, and converts the image data obtained by reading the document into the file format set at the host computer 101. However, some scanning apparatuses that can be connected to the host computer 101 limit the file format to be converted. In this case, even if the file format set by the user using the file format setting function supported by the expansion application 201 is written in the scan setting information, some scanning apparatuses cannot convert the format of the image data obtained by reading a document into the set file format.

Therefore, whether the scanning apparatus 102 can convert into the file format set by the user using the file format setting function is determined based on the capability information of the scanning apparatus 102 in the second embodiment. When the scanning apparatus 102 can convert into the file format set by the user using the file format setting function, the file format is written in the scan setting information. Further, the scan instruction command generated based on the scan setting information is transmitted to the scanning apparatus 102.

In contrast, when the scanning apparatus 102 cannot convert into the file format set by the user using the file format setting function, another file format that can be set by the scanning apparatus 102 is written in the scan setting information. Further, a scan instruction command generated based on the scan setting information is transmitted to the scanning apparatus 102. Note that a scan instruction command including an instruction command to keep the image data to be transmitted to the host computer 101 as a bitmap image at the time of reading the document, instead of the file format that can be set by the scanning apparatus 102, may be transmitted to the scanning apparatus 102. Thereafter, the image data obtained by reading the document by the scanning apparatus 102 is converted into the file format set by the user using the file format setting function with the expansion application 201. Thus, even when the user sets the file format that cannot be converted by the scanning apparatus 102, the expansion application 201 can provide the image data obtained by reading the document by the scanning apparatus 102 in the file format set by the user.

Hereinafter, only the differences from the first embodiment will be described in the second embodiment. The capability information obtained from the scanning apparatus 102 shall not include the function-and-option of “file format: PDF”. The expansion application 201 differs from the expansion application 201 in the first embodiment in the following point. Even if a certain file format is unsupported by the scanning apparatus, if the expansion application 201 includes a module that can convert into the certain file format, the scan function expansion unit 206 adds the certain file format to the scan function information 204 as an option of the function of the file format. The image data editing unit 207 converts the image data obtained from the scanning apparatus 102 into the file format set by the user using the file format setting function. The details of these will be described below.

Hereinafter, a flow of the editing process for the scan function information 204 performed by the scan function expansion unit 206 of the expansion application 201 in the second embodiment will be described using a flowchart shown in FIG. 9. Steps in FIG. 9 indicated by the same reference numerals as the steps in FIG. 4 are the same processes, and therefore, the descriptions thereof will be omitted. Each step of the flowchart shown in FIG. 9 is achieved by the CPU 111 in the host computer 101 executing the expansion application 201 that is read from the external storage device 114 and developed onto the RAM 113. In the flowchart in FIG. 9, when the repetitive process from the step S404 to the step S406 is finished, the processing proceeds to a step S901.

Note that the scanning apparatus 102 in the second embodiment does not support “PDF” as an option of a file format function, unlike the first embodiment, as described above. Therefore, the scan function information 204 at the time when the repetitive process from the step S404 to the step S406 is completed does not include “PDF” in the options of the file format function. Therefore, a process of adding an option of the file format function, which is not included in the capability information obtained from the scanning apparatus 102, to the scan function information 204 is performed in accordance with a module included in the expansion application 201 in steps S901 and S902.

Specifically, the CPU 111 determines with the scan function expansion unit 206 whether the expansion application 201 includes a module that converts to a file format unsupported by the scanning apparatus 102 in the step S901. The scan function expansion unit 206 determines in the step S901 by referring to the scan function information 204 and the capability information obtained from the scanning apparatus 102 in the step S401. When the CPU 111 determines with the scan function expansion unit 206 that the expansion application 201 includes a module that converts to a file format unsupported by the scanning apparatus 102, the process proceeds to the step S902. On the other hand, when the CPU 111 determines with the scan function expansion unit 206 that the expansion application 201 does not include a module that converts to a file format unsupported by the scanning apparatus 102, the process of the flowchart in FIG. 9 ends.

Since the image data editing unit 207 can convert image data into the file format of PDF, the process proceeds to the step S902 in the second embodiment. In the next step S902, the CPU 111 adds, with the scan function expansion unit 206, the file format after the format conversion by the module that is subjected to the determination in the step S901 to the options of the file format function of the scan function information 204. As a result, “PDF” is added to the options of the file format function of the scan function information 204 in the second embodiment. Thereafter, the process of the flowchart in FIG. 9 ends.

As described above, the following process is performed in the second embodiment. First, the function-and-option that is not supported by the general-purpose scan software 202 and is supported by the scanning apparatus 102 and the expansion application 201 is added to the scan function information 204. Thereafter, when it is determined that the expansion application 201 includes a module for converting the format into the file format unsupported by the scanning apparatus 102, the file format is added to the options of the file format function of the scan function information 204. Further, the display screen is generated based on the scan capability determined by the scan function information 204. Thus, the file format unsupported by the scanning apparatus 102 with the file format function can be displayed in the control 307 or the list 308 on the advanced setting screen shown in FIG. 3C.

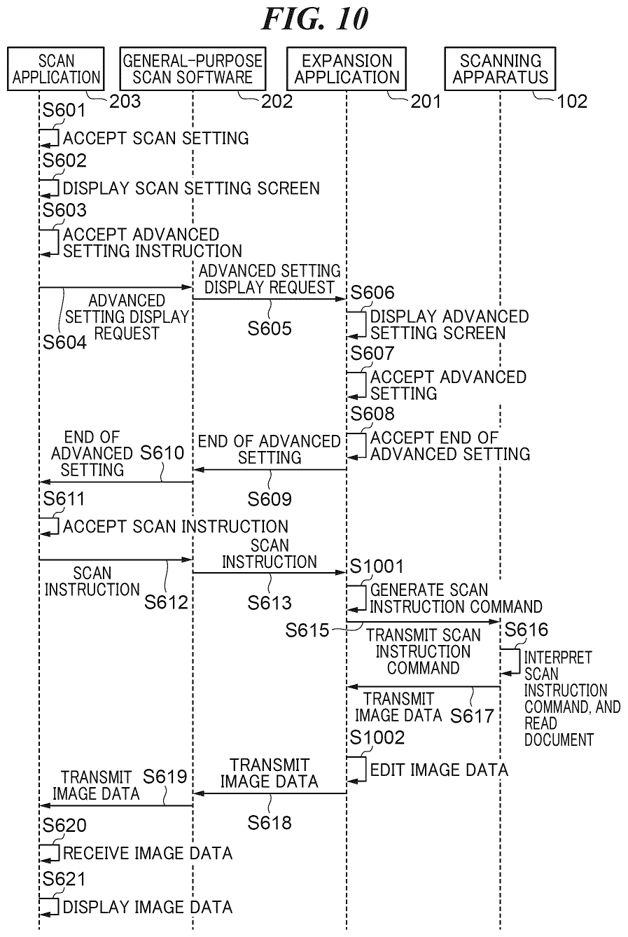

Next, a sequence (method) of the scanning process executed by the scan application 203, the general-purpose scan software 202, the expansion application 201, and the scanning apparatus 102 after the scan application 203 accepts the scan setting will be described with reference to FIG. 10. Steps in FIG. 10 indicated by the same reference numerals as the steps in FIG. 6 are the same processes, and therefore, the descriptions thereof will be omitted. Steps other than steps of the scanning apparatus 102 in FIG. 10 are implemented by the CPU 111 activating the scan application 203, general-purpose scan software 202, and expansion application 201 in the host computer 101. On the other hand, the steps of the scanning apparatus 102 in FIG. 10 are achieved by the CPU 131 developing a program read from the ROM 132 or the external storage device 139 onto the RAM 133 and executing the program in the scanning apparatus 102.

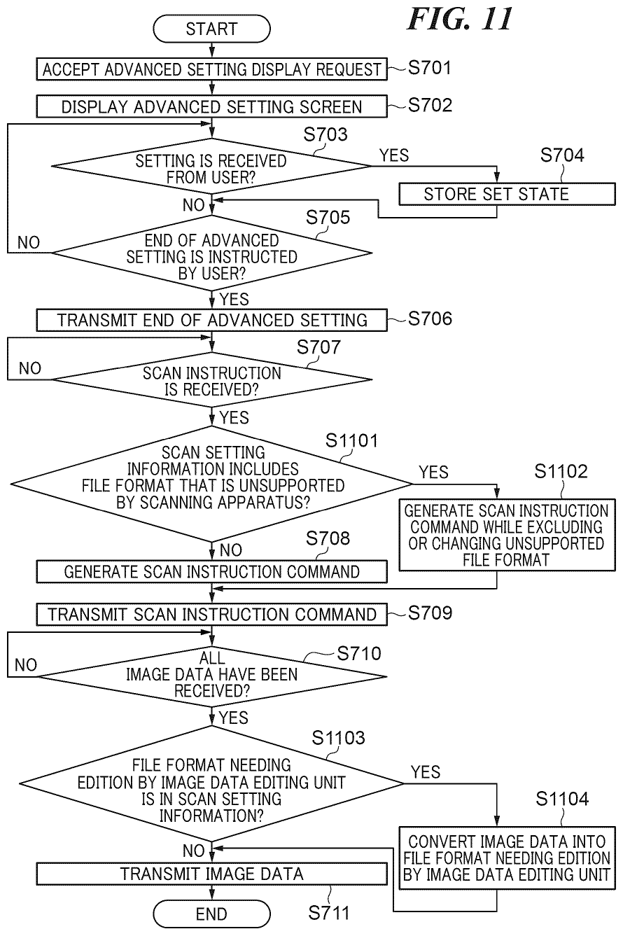

The CPU 111 generates a scan instruction command with the expansion application 201 in a step S1001. The details of the generation of the scan instruction command in the second embodiment will be described later with reference to FIG. 11. The CPU 111 edits the image data with the image data editing unit 207 of the expansion application 201 in a step S1002. The expansion application 201 converts the image data obtained from the scanning apparatus 102 by editing the image data into the file format set by the user using the file format setting function. The above is the description of the sequence after the scan application 203 accepts the scan setting in the second embodiment.

Next, a process flow of the expansion application 201 after the scan application 203 in the second embodiment accepts the scan setting will be described with reference to FIG. 11. Steps in FIG. 11 indicated by the same reference numerals as the steps in FIG. 7 are the same processes, and therefore, the descriptions thereof will be omitted. Each step shown in the flowchart in FIG. 11 is achieved by the CPU 111 developing the expansion application 201 read from the external storage device 114 onto the RAM 113 and executing the expansion application in the host computer 101.

The CPU 111 first obtains, with the expansion application 201, the capability information of the scanning apparatus 102 from the shared information 209 in a step S1101. If the capability information of the scanning apparatus 102 is not included in the shared information 209, the scan function expansion unit 206 may request the scanning apparatus 102 to transmit the capability information, and may store the capability information obtained from the scanning apparatus 102 in the shared information 209. Next, the CPU 111 determines with the expansion application 201 whether the scan setting information includes a set state of the file format unsupported by the scanning apparatus 102. The expansion application 201 determines in the step S1101 by referring to the obtained capability information of the scanning apparatus 102 and the scan setting information.

When the CPU 111 determines with the expansion application 201 that the scan setting information includes the set state of the file format unsupported by the scanning apparatus 102, the process proceeds to a step S1102. On the other hand, when the CPU 111 determines with the expansion application 201 that the scan setting information does not include the set state of the file format unsupported by the scanning apparatus 102, the process proceeds to the step S708 described above. Next, the CPU 111 generates, with the expansion application 201, a scan instruction command by excluding or changing the set state of the file format unsupported by the scanning apparatus 102 in the step S1102. As a result, the scan instruction command does not include the file format set by the user, but includes a file format (another file format) that can be set (that is, supported) by the scanning apparatus 102.

The CPU 111 determines with the expansion application 201 whether the scan setting information includes a set state of the file format needing edition by the image data editing unit 207 in a step S1103. When the CPU 111 determines with the expansion application 201 that the scan setting information includes the set state of the file format needing edition by the image data editing unit 207, the process proceeds to a step S1104. On the other hand, when the CPU 111 determines with the expansion application 201 that the scan setting information does not include a set state of the file format needing edition by the image data editing unit 207, the process proceeds to the step S711 described above.

In the second embodiment, when the scan setting information includes the set state of the file format of PDF that is unsupported by the scanning apparatus 102, the process proceeds to the step S1104. Next, the CPU 111 converts the format of the image data obtained from the scanning apparatus 102 into the file format set by the user using the file format setting function with the image data editing unit 207 of the expansion application 201 in the step S1104. The above is the description of the process flow of the expansion application 201 after the scan application 203 receives the scan setting in the second embodiment.

As described above, the expansion application 201 can set the file format, which is unsupported by the scanning apparatus 102, by the file format setting function when the user uses the general-purpose scan software 202 in the host computer 101.

In the second embodiment, the set state of the file format unsupported by the scanning apparatus 102 is excluded from the scan instruction command or changed. However, even if the scan instruction command includes an unsupported set state of the file format, the scanning apparatus 102 cannot interpret and execute the set state. Therefore, the set state of the file format unsupported by the scanning apparatus 102 may not be excluded from the scan instruction command nor changed. This point is the same for functions other than the fill format and their options.

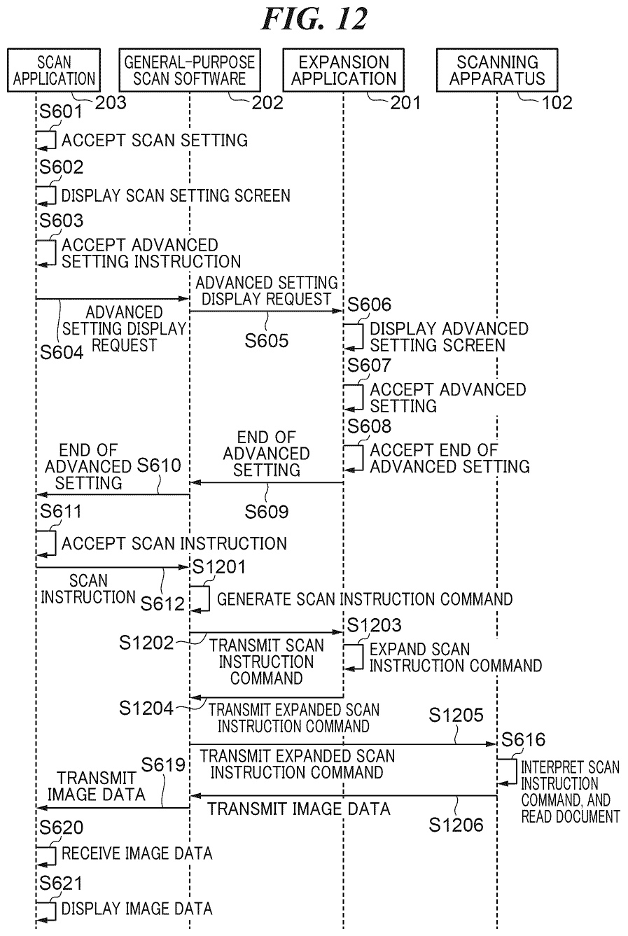

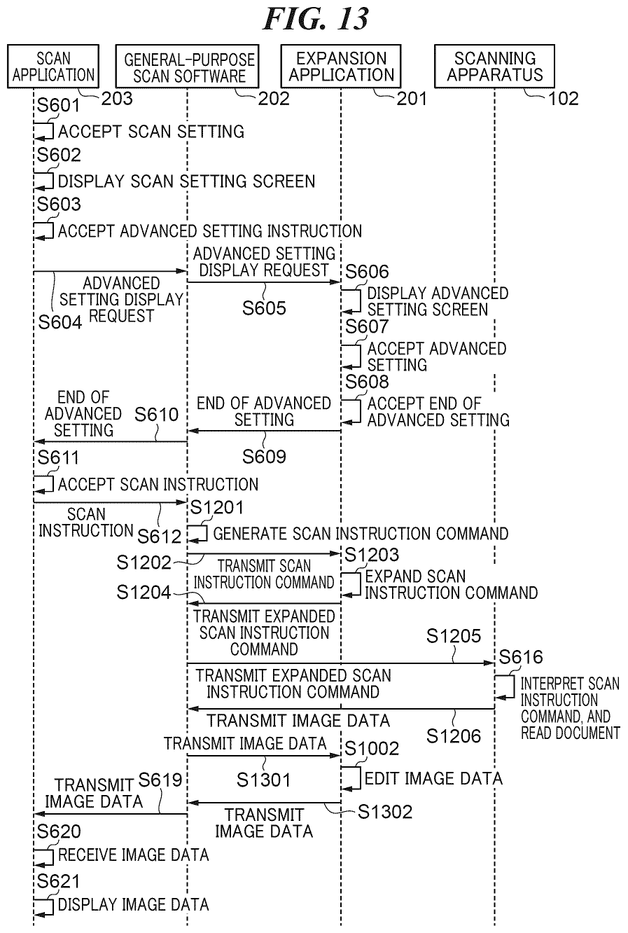

A third embodiment will now be described with reference to FIGS. 12 and 13. In the first and second embodiments, the scan instruction command and the image data are transmitted and received between the expansion application 201 of the host computer 101 and the scanning apparatus 102. On the other hand, in the third embodiment, the scan instruction command and the image data are transmitted and received between the general-purpose scan software 202 of the host computer 101 and the scanning apparatus 102. The expansion application 201 expands the scan instruction command and edits the image data. The following description of the third embodiment focuses only differences from the first and second embodiments.

First, only differences from the first embodiment will be described with reference to FIG. 12. FIG. 12 illustrates a sequence (method) of the scanning process executed by the scan application 203, the general-purpose scan software 202, the expansion application 201, and the scanning apparatus 102 after the scan application 203 accepts the scan setting. Steps in FIG. 12 indicated by the same reference numerals as the steps in FIG. 6 are the same processes, and therefore, the descriptions thereof will be omitted. Steps other than steps of the scanning apparatus 102 in FIG. 12 are implemented by the CPU 111 activating the scan application 203, general-purpose scan software 202, and expansion application 201 in the host computer 101. On the other hand, the steps of the scanning apparatus 102 in FIG. 12 are achieved by the CPU 131 developing a program read from the ROM 132 or the external storage device 139 onto the RAM 133 and executing the program in the scanning apparatus 102.

The CPU 111 generates the scan instruction command with the general-purpose scan software 202 in a step S1201. At this time, the general-purpose scan software 202 excludes the function-and-option unsupported by the general-purpose scan software 202 from the scan instruction command. The CPU 111 transmits the generated scan instruction command to the expansion application 201 with the general-purpose scan software 202 in a step S1202. the CPU 111 expands the scan instruction command with the expansion application 201 in a step S1203.

At this time, the expansion application 201 adds an instruction command of a function-and-option unsupported by the general-purpose scan software 202 to the received scan instruction command or changes an instruction existing in the received scan instruction command. Since the scan instruction command generated with the general-purpose scan software 202 in the step S1201 does not include the set state set by the user using the file format setting function, this set state is added to the scan instruction command. In this way, the set state of the function-and-option supported only by the expansion application 201 is added to the scan instruction command generated by the general-purpose scan software 202.

The CPU 111 transmits the expanded scan instruction command to the general-purpose scan software 202 with the expansion application 201 in a step S1204. The CPU 111 transmits the expanded scan instruction command expanded by the expansion application 201 to the scanning apparatus 102 with the general-purpose scan software 202 in a step S1205. As a result, the general-purpose scan software 202 issues the scan instruction to the scanning apparatus 102. The CPU 111 obtains the image data by receiving it from the scanning apparatus 102 with the general-purpose scan software 202 in a step S1206. The above is the description of the sequence after the scan application 203 accepts the scan setting in the differences between the third embodiment and the first embodiment.

In this case, the process flow of the expansion application 201 illustrated in FIG. 7 is different from that in the first embodiment in the following points. The CPU 111 determines whether the expansion application 201 receives the scan instruction command from the general-purpose scan software 202 in the step S707. When the CPU 111 determines that the expansion application 201 receives the scan instruction command from the general-purpose scan software 202, the process proceeds to the step S708. On the other hand, when the CPU 111 determines that the expansion application 201 does not received the scan instruction command from the general-purpose scan software 202, the process returns to the step S707. Thus, the CPU 111 determines whether the scan instruction command is received from the general-purpose scan software 202 with the expansion application 201 again.

The CPU 111 expands the scan instruction command based on the scan setting information written in the step S705 with the expansion application 201 in the step S708. As a result, the expansion application 201 adds the instruction command of the function-and-option unsupported by the general-purpose scan software 202 to the received scan instruction command or changes an instruction existing in the received scan instruction command. Next, the CPU 111 transmits the expanded scan instruction command to the general-purpose scan software 202 with the expansion application 201 in the step S709. Note that the processes in the steps S710 and S711 are not executed.

Next, only differences from the second embodiment will be described with reference to FIG. 13. FIG. 13 illustrates a sequence (method) of the scanning process executed by the scan application 203, the general-purpose scan software 202, the expansion application 201, and the scanning apparatus 102 after the scan application 203 accepts the scan setting. Steps in FIG. 13 indicated by the same reference numerals as the steps in FIG. 12 are the same processes, and therefore, the descriptions thereof will be omitted. Steps other than steps of the scanning apparatus 102 in FIG. 13 are implemented by the CPU 111 activating the scan application 203, general-purpose scan software 202, and expansion application 201 in the host computer 101. On the other hand, the steps of the scanning apparatus 102 in FIG. 12 are achieved by the CPU 131 developing a program read from the ROM 132 or the external storage device 139 onto the RAM 133 and executing the program in the scanning apparatus 102.

The CPU 111 obtains the image data by receiving it from the general-purpose scan software 202 with the expansion application 201 in a step S1301. The CPU 111 edits the image with the expansion application 201 in the step S1002. At this time, the expansion application 201 converts the format of the image data obtained from the general-purpose scan software 202 into the file format set by the user using the file format setting function with the image data editing unit 207. The CPU 111 transmits the edited image data to the general-purpose scan software 202 with the expansion application 201 in a step S1302. The above is the description of the sequence after the scan application 203 accepts the scan setting in the differences between the third embodiment and the second embodiment.

In this case, the steps S707, S708, and S709 in the process flow of the expansion application illustrated in FIG. 11 are the same as those in the case where the differences from the first embodiment are described. The CPU 111 generates, in the step S1102, the scan instruction command (instruction command) in the same manner as in the step S708. However, the expansion application 201 expands the scan instruction command by excluding or changing the set state of the file format unsupported by the scanning apparatus 102. Thus, the expanded scan instruction command does not include the file format set by the user, but includes the file format that can be set in the scanning apparatus 102.

The CPU 111 determines with the expansion application 201 whether all image data have been received from the general-purpose scan software 202 in the step S710. When the CPU 111 determines with the expansion application 201 that all the image data have been received from the general-purpose scan software 202, the process proceeds to the step S711. On the other hand, when the CPU 111 determines with the expansion application 201 that not all the image data have been received from the general-purpose scan software 202, the process returns to the step S710. As a result, the expansion application 201 determines whether all the image data have been received from the general-purpose scan software 202 again.

As described above, the scan instruction command and the image data are transmitted and received between the general-purpose scan software 202 of the host computer 101 and the scanning apparatus 102 in the third embodiment. Even in such a case, the expansion application 201 can use the file format setting function when the user uses the general-purpose scan software 202 in the host computer 101 by expanding the scan instruction command. The expansion application 201 can also set the file format unsupported by the scanning apparatus 102 by the user using the file format setting function by expanding the scan instruction command and editing the image data.

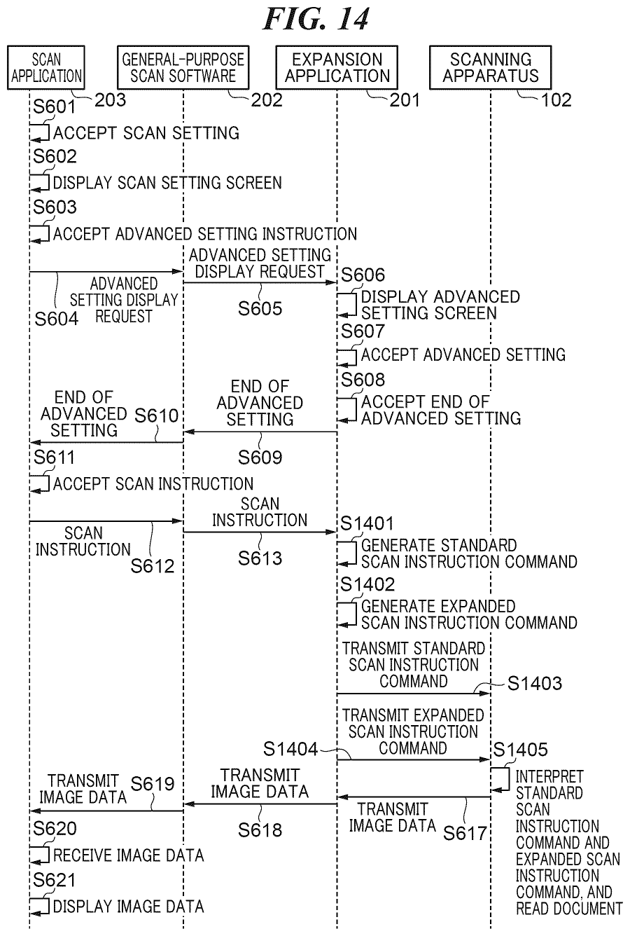

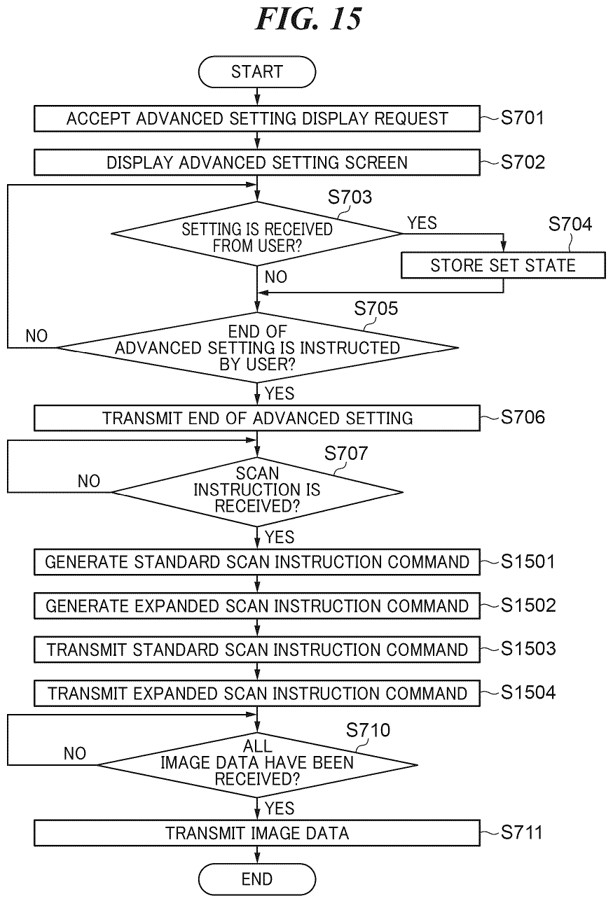

A fourth embodiment will now be described with reference to FIGS. 14 and 15. In the first, second, and third embodiments, the scan instruction command generated or expanded by the method of expanding the command of the standard protocol is transmitted to the scanning apparatus 102. On the other hand, a scan instruction command other than the command generated by expanding the command of the standard protocol is transmitted to the scanning apparatus 102 about the function-and-option supported only by the expansion application 201 in the fourth embodiment. Hereinafter, only differences from the first embodiment will be described in the fourth embodiment, but the descriptions about only differences from the second and third embodiments are also similar.

FIG. 14 illustrates a sequence (method) of the scanning process executed by the scan application 203, the general-purpose scan software 202, the expansion application 201, and the scanning apparatus 102 after the scan application 203 accepts the scan setting. Steps in FIG. 14 indicated by the same reference numerals as the steps in FIG. 6 are the same processes, and therefore, the descriptions thereof will be omitted. Steps other than steps of the scanning apparatus 102 in FIG. 14 are implemented by the CPU 111 activating the scan application 203, general-purpose scan software 202, and expansion application 201 in the host computer 101. On the other hand, the steps of the scanning apparatus 102 in FIG. 14 are achieved by the CPU 131 developing a program read from the ROM 132 or the external storage device 139 onto the RAM 133 and executing the program in the scanning apparatus 102.

The CPU 111 generates, with the expansion application 201, a standard scan instruction command confirming to the standard protocol in a step S1401. Thus, the expansion application 201 generates the standard scan instruction command including the set state of the function-and-option supported by the general-purpose scan software 202. Therefore, at this time, the expansion application 201 excludes the set state of the function-and-option unsupported by the standard protocol (i.e., the general-purpose scan software 202) from the standard scan instruction command. The CPU 111 generates, with the expansion application 201, an expanded scan instruction command including the set state of the function-and-option supported only by the expansion application 201 in a step S1402. That is, the expansion application 201 generates the expanded scan instruction command including the set state of the function-and-option unsupported by the standard protocol (i.e., the general-purpose scan software 202).

The CPU 111 transmits the standard scan instruction command to the scanning apparatus 102 with the expansion application 201 in a step S1403. The CPU 111 transmits the expanded scan instruction command to the scanning apparatus 102 with the expansion application 201 in a step S1404. By transmitting the standard scan instruction command and the extended scan instruction command, the expansion application 201 issues the scan instruction to the scanning apparatus 102. The CPU 131 of the scanning apparatus 102 interprets the standard scan instruction command and the expanded scan instruction command received, and reads a document in a step S1405. The above is the description of the sequence after the scan application 203 accepts the scan setting in the fourth embodiment.

Next, a process flow of the expansion application 201 after the scan application 203 in the fourth embodiment accepts the scan setting will be described with reference to FIG. 15. Steps in FIG. 15 indicated by the same reference numerals as the steps in FIG. 7 are the same processes, and therefore, the descriptions thereof will be omitted. Each step shown in the flowchart in FIG. 15 is achieved by the CPU 111 developing the expansion application 201 read from the external storage device 114 onto the RAM 113 and executing the expansion application in the host computer 101.

The CPU 111 generates, with the expansion application 201, the standard scan instruction command (standard instruction command) conforming to the standard protocol in a step S1501. That is, the expansion application 201 generates the standard scan instruction command including the set state of the function-and-option supported by the general-purpose scan software 202. The CPU 111 generates, with the expansion application 201, the expanded scan instruction command (expanded instruction command) including the set state of the function-and-option supported only by the expansion application 201 in a step S1502. That is, the expansion application 201 generates the expanded scan instruction command including the set state of the function-and-option (for example, the set state of the file format) unsupported by the standard protocol (i.e., the general-purpose scan software 202).

In a step S1503, the CPU 111 transmits, with the expansion application 201, the standard scan instruction command generated in the step S1501 to the scanning apparatus 102. In a step S1504, the CPU 111 transmits, with the expansion application 201, the extended scan instruction command generated in the step S1502 to the scanning apparatus 102. The above is the description of the process flow of the expansion application 201 after the scan application 203 receives the scan setting in the fourth embodiment.

In this case, the CPU131 receives the standard scan instruction command and the expanded scan instruction command transmitted from the expansion application 201 of the host computer 101 in the step S801 in the process flow of the scanning apparatus 102 shown in FIG. 8. Next, the CPU131 analyzes, in the step S802, the standard scan instruction command and the expanded scan instruction command received in the step S801, and converts the scan instruction commands into the reading set state used when reading a document. In the step S809, the CPU 131 converts, with the image processor 138, the format of the image data stored in the step S807 in accordance with the expanded scan instruction command received in the step S801.

As described above, the expansion application 201 generates the standard scan instruction command for the function-and-option unsupported by the standard protocol and transmits the standard scan instruction command to the scanning apparatus 102 in the fourth embodiment. Further, the expansion application 201 generates the expanded scan instruction command for the function-and-option (for example, the file format setting function) supported only by the expansion application 201 and transmits the extended scan instruction command to the scanning apparatus 102. In this way, the expansion application 201 can make the file format setting function usable when the user uses the general-purpose scan software 202 in the host computer 101 by transmitting the expanded scan instruction command to the scanning apparatus 102.

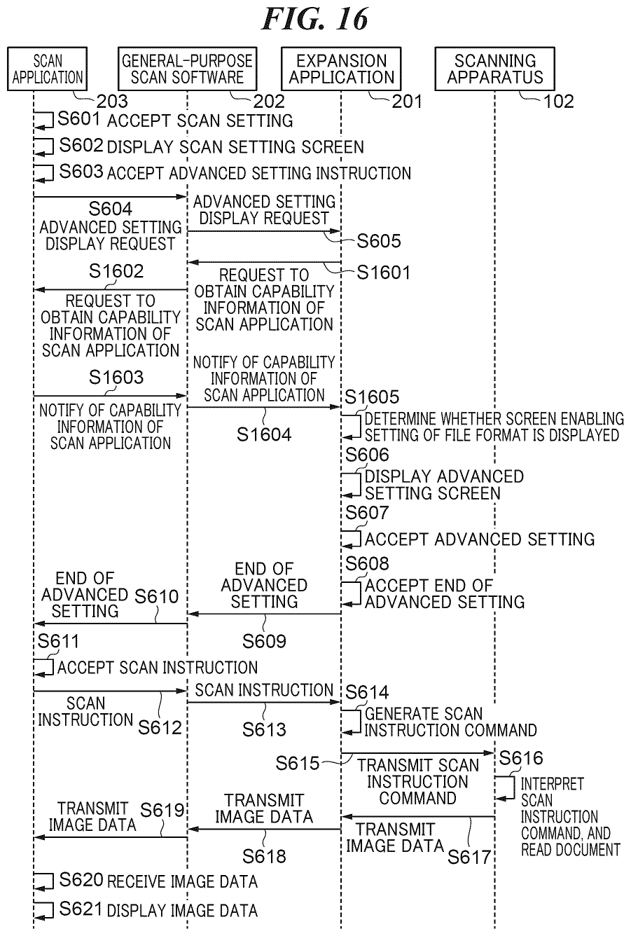

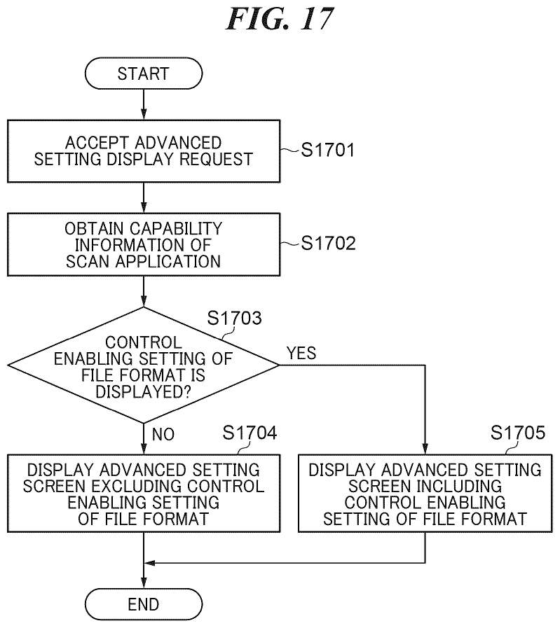

A fifth embodiment will now be described with reference to FIGS. 16 and 17. In the first, second, third, and fourth embodiments, the expansion application 201 receives the advanced setting display request from the scan application 203, and the scan-setting-screen expansion unit 205 displays the advanced setting screen in FIG. 3C on the display unit 120. However, some scan applications 203 may be better not to display the advanced setting screen on which the file format can be set. For example, when the user uses the scan function in an image editing application, the user may want to take bitmap image data into the image editing application from the scanning apparatus 102 and edit the image data without converting a file format of the image data into a specific file format. As described above, there are some use cases that may be better not to set the file format by the user. The fifth embodiment corresponding to such a use case will be described. Hereinafter, only differences from the first embodiment will be described in the fifth embodiment, but the descriptions about only differences from the second, third, and fourth embodiments are similar.

FIG. 16 illustrates a sequence (method) of the scanning process executed by the scan application 203, the general-purpose scan software 202, the expansion application 201, and the scanning apparatus 102 after the scan application 203 accepts the scan setting. Steps in FIG. 16 indicated by the same reference numerals as the steps in FIG. 6 are the same processes, and therefore, the descriptions thereof will be omitted. Steps other than steps of the scanning apparatus 102 in FIG. 16 are implemented by the CPU 111 activating the scan application 203, general-purpose scan software 202, and expansion application 201 in the host computer 101. On the other hand, the steps of the scanning apparatus 102 in FIG. 16 are achieved by the CPU 131 developing a program read from the ROM 132 or the external storage device 139 onto the RAM 133 and executing the program in the scanning apparatus 102.

The CPU 111 requests the general-purpose scan software 202 to obtain the capability information of the scan application 203 with the expansion application 201 in a step S1601. The CPU 111 requests the scan application 203 to obtain the capability information of the scan application 203 with the general-purpose scan software 202 in a step S1602. The CPU 111 notifies the general-purpose scan software 202 of the capability information of the scan application 203 by using the scan application 203 in a step S1603.

The CPU 111 notifies the expansion application 201 of the capability information of the scan application 203 by using the general-purpose scan software 202 in a step S1604. The CPU 111 determines with the expansion application 201 whether the advanced setting screen in FIG. 3C on which the file format can be set or the advanced setting screen in FIG. 3B on which the file format cannot be set should be displayed on the display unit 120 in a step S1605. The details of the process related to this determination will be described later with reference to FIG. 17. When the CPU 111 generates the scan instruction command with the expansion application 201 in the step S614, an instruction command to keep the image data to be transmitted to the host computer 101 as a bitmap image is embedded into the scan instruction command. The above is the description of the sequence after the scan application 203 accepts the scan setting in the fifth embodiment.

FIG. 17 is a flowchart illustrating an operation when the expansion application 201 switches the advanced setting screen. Each step shown in the flowchart in FIG. 17 is achieved by the CPU 111 by developing the expansion application 201 read from the external storage device 114 onto the RAM 113 and executing the expansion application in the host computer 101. When the process of the flowchart in FIG. 17 is started, the CPU 111 accepts the advanced setting display request with the expansion application 201 in a step S1701. The CPU 111 obtains the capability information of the scan application 203 from the general-purpose scan software 202 with the expansion application 201 in a step S1702. The capability information of the scan application 203 obtained by the expansion application 201 includes information indicating whether the scan application 203 has an export function for the set state of the file format.

In a step S1703, the CPU 111 determines with the expansion application 201 whether a control enabling setting of the file format should be displayed based on the capability information of the scan application 203 obtained in the step S1702. The expansion application 201 performs this determination based on the capability information of the scan application 203 (application) obtained in the step S1702. Further, the expansion application 201 performs this determination by determining whether the scan application 203 has both the export function of the set state of the file format and the image editing function. Alternatively, the expansion application 201 may perform this determination based on whether the scan application 203 has one of the export function of the set state of the file format and the image editing function, instead of both of the functions. The expansion application 201 may determine whether to display the control enabling setting of the file format using the capability information of another scan application 203.

When the CPU 111 determines with the expansion application 201 that the control enabling setting of the file format should not be displayed, the process proceeds to a step S1704. On the other hand, when the CPU 111 determines with the expansion application 201 that the control enabling setting of the file format should be displayed, the process proceeds to a step S1705. The CPU 111 displays the advanced setting screen in FIG. 3B on which the control 307 enabling setting of the file format is not included on the display unit 120 with the scan-setting-screen expansion unit 205 of the expansion application 201 in the step S1704. As a result, the control 307 etc. that enable setting of the file format are hidden. In this case, the advanced setting screen in FIG. 3B is displayed on the display unit 120 in the step S606. Thereafter, the process of the flowchart in FIG. 17 ends.

The CPU 111 displays the advanced setting screen in FIG. 3C on which the control 307 enabling setting of the file format on the display unit 120 with the scan-setting-screen expansion unit 205 of the expansion application 201 in the step S1705. As a result, the control 307 etc. that enable setting of the file format are displayed on the display unit 120. In this case, the advanced setting screen in FIG. 3C is displayed on the display unit 120 in the step S606. Thereafter, the process of the flowchart in FIG. 17 ends.

As described above, the expansion application 201 can make the file format setting function usable when the user uses the general-purpose scan software 202 in the host computer 101 in accordance with the capability information of the scan application 203 in the fifth embodiment.

Although the preferred embodiments of the present invention have been described above, the present invention is not limited to the above-described embodiments, and various modifications and changes can be made within the scope of the gist of the present invention. For example, the CPU 111 of the host computer 101 may switch the display or non-display of the advanced setting screen in FIG. 3C in accordance with the capability information of the scanning apparatus 102 with the expansion application 201. For example, unlike the embodiments, when the function-and-option of the file format is unsupported by the scanning apparatus 102, the advanced setting screen in FIG. 3C may not be displayed. In this case, the advanced setting screen in FIG. 3B is displayed on the display unit 120.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-049485, filed Mar. 26, 2024, which is hereby incorporated by reference herein in its entirety.

What is claimed is:

1. A non-transitory computer-readable storage medium storing a program that supports software capable of commonly being used in image processing apparatuses of a plurality of manufactures and causes a computer of an information processing apparatus to execute a method comprising:
displaying a screen through which a user operation to set a file format of image data that is obtained by reading a document by an image processing apparatus is received; and
setting the file format of the image data in accordance with the user operation accepted through the screen.

2. The non-transitory computer-readable storage medium according to claim 1, wherein the method further comprises generating a command including a set state of the file format accepted through the screen as an instruction command to the image processing apparatus.

3. The non-transitory computer-readable storage medium according to claim 1, wherein the method further comprises converting a format of image data received from the image processing apparatus into the file format accepted through the screen.

4. The non-transitory computer-readable storage medium according to claim 3, wherein the method further comprises generating a command excluding a set state of the file format accepted through the screen as an instruction command to the image processing apparatus.

5. The non-transitory computer-readable storage medium according to claim 4, wherein the method further comprises generating a command including a set state of another file format supported by the image processing apparatus as the instruction command to the image processing apparatus.

6. The non-transitory computer-readable storage medium according to claim 1, wherein the method further comprises transmitting an instruction command to the image processing apparatus via the software.

7. The non-transitory computer-readable storage medium according to claim 6, wherein the method further comprises generating the instruction command to the image processing apparatus by embedding a set state of a function-and-option supported only by the program into a command generated by the software.

8. The non-transitory computer-readable storage medium according to claim 1, wherein the method further comprises generating a standard instruction command including a set state of a function-and-option supported by the software and an expanded instruction command including a set state of a function-and-option supported only by the program as instruction commands to the image processing apparatus.

9. The non-transitory computer-readable storage medium according to claim 7, wherein the set state of the function-and-option supported only by the program includes at least a set state of the file format accepted through the screen.

10. The non-transitory computer-readable storage medium according to claim 1, wherein the method further comprises switching display or non-display of a control to accept the file format on the screen in accordance with capability information of an application to take in the image data.

11. The non-transitory computer-readable storage medium according to claim 1, wherein the method further comprises changing a control displayed on the screen in accordance with capability information of the software.

12. The non-transitory computer-readable storage medium according to claim 1, wherein the method further comprises changing a control displayed on the screen in accordance with capability information of the image processing apparatus.

13. The non-transitory computer-readable storage medium according to claim 1, wherein the method further comprises switching display or non-display of the screen in accordance with capability information of the image processing apparatus.

14. The non-transitory computer-readable storage medium according to claim 1, wherein the file format acceptable through the screen is one of PDF, JPEG, TIFF, XPS, OOXML, PNG, DOC, PPT, XLS, TXT, and CSV.

15. The non-transitory computer-readable storage medium according to claim 1, wherein the method further comprises accepting a set state of an additional option included in a set state of the file format on the screen.

16. The non-transitory computer-readable storage medium according to claim 15, wherein a setting item of the additional option acceptable through the screen is changed in accordance with a file format acceptable through the screen.

17. The non-transitory computer-readable storage medium according to claim 15, wherein the additional option acceptable through the screen is at least one of PDF/A, high compression, OCR, encryption, electronic signature addition, and per-page division.

18. The non-transitory computer-readable storage medium according to claim 1, wherein the method further comprises generating an instruction command to the image processing apparatus by expanding a command of a standard protocol.

19. The non-transitory computer-readable storage medium according to claim 1, wherein the method further comprises generating an instruction command to the image processing apparatus by using a command unique to the program or the manufacturer.

20. A control method for an information processing apparatus executing a program that supports software capable of commonly being used in image processing apparatuses of a plurality of manufactures, the control method comprising:
displaying a screen through which a user operation to set a file format of image data that is obtained by reading a document by an image processing apparatus is received; and
setting the file format of the image data in accordance with the user operation accepted through the screen.

21. An information processing apparatus executing a program that supports software capable of commonly being used in image processing apparatuses of a plurality of manufactures, the information processing apparatus comprising:
a display control unit configured to display a screen through which a user operation to set a file format of image data that is obtained by reading a document by an image processing apparatus is received; and
a setting unit configured to set the file format of the image data in accordance with to the user operation accepted through the screen.
